(19) United States
(12) Patent Application Publication
(10) Pub. No.: US 2021/0016793 A1
(43) Pub. Date: Jan. 21, 2021

(54) CONTROL APPARATUS, DISPLAY APPARATUS, MOVABLE BODY, AND IMAGE DISPLAY METHOD

(71) Applicants: Hiroshi YAMAGUCHI, Kanagawa (JP); Kenichiroh SAISHO, Tokyo (JP); Masato KUSANAGI, Kanagawa (JP); Yuuki SUZUKI, Kanagawa (JP); Keita KATAGIRI, Kanagawa (JP)

(72) Inventors: Hiroshi YAMAGUCHI, Kanagawa (JP); Kenichiroh SAISHO, Tokyo (JP); Masato KUSANAGI, Kanagawa (JP); Yuuki SUZUKI, Kanagawa (JP); Keita KATAGIRI, Kanagawa (JP)

(21) Appl. No.: 17/041,325

(22) PCT Filed: Mar. 27, 2019
(86) PCT No.: PCT/JP2019/013470

§ 371 Date: Sep. 24, 2020

(30) Foreign Application Priority Data
Mar. 28, 2018 (JP) 2018-062548
Mar. 29, 2018 (JP) 2018-063760
Mar. 29, 2018 (JP) 2018-066207
Mar. 18, 2019 (JP) 2019-050377
Mar. 18, 2019 (JP) 2019-050441

(51) Int. Cl. B60W 60/00; G06T 11/00; B60K 35/00; B60W 50/14; G02B 27/01; G01C 21/36; G08G 1/16

(52) U.S. Cl. CPC B60W 60/001; G06T 11/00; B60K 35/00; B60W 50/14; G02B 27/0101; G01C 21/3697; B60K 2370/177; G01C 21/365; G08G 1/166; B60W 2050/146; G02B 2027/0141; B60K 2370/1529; B60K 2370/175; G01C 21/3602

(57) ABSTRACT

(Object) To provide information to the occupant of the movable body by which the occupant can feel a higher sense of security, when there is a change in the travel path. (Means of Achieving the object) A control apparatus includes an image data generator configured to generate image data of an image displayed so as to appear to be superimposed on a surrounding environment as viewed from an occupant of a movable body that autonomously travels based on a planned path that is defined in advance, wherein a display mode of the image is changed based on information indicating a change in at least one of a travelling direction of the movable body and external information of the movable body.

### TECHNICAL FIELD

The present invention relates to a control apparatus, a display apparatus, a movable body, and an image display method.

### BACKGROUND ART

Recently, there is known a technology to recognize the surrounding environment of a movable body by a camera, a Global Positioning System (GPS), radar, Laser Imaging Detection and Ranging (LIDAR), etc., and to autonomously travel along a path to a predetermined destination.

Also, there is known a technology to display a planned travel path to the occupant, when the movable body is travelling autonomously (see, e.g., Patent Literature 1).

### CITATION LIST

### Patent Literature

PTL 1: Japanese Laid-Open Patent Application No. 2017-211366

PTL 2: Japanese Laid-Open Patent Application No. 2016-145783

PTL 3: Japanese Laid-Open Patent Application No. 2002-144913

### SUMMARY OF INVENTION

### Technical Problem

However, it has not been possible to provide information to the occupant of the movable body by which the occupant can feel a higher sense of security, when there is a change in the travel path.

### Solution to Problem

An aspect of the present invention provides a control apparatus including an image data generator configured to generate image data of an image displayed so as to appear to be superimposed on a surrounding environment as viewed from an occupant of a movable body that autonomously travels based on a planned path that is defined in advance, wherein a display mode of the image is changed based on information indicating a change in at least one of a travelling direction of the movable body and external information of the movable body.

### Advantageous Effects of Invention

According to the present disclosure, information can be provided to the occupant of the movable body by which the occupant can feel a higher sense of security, when there is a change in the travel path.

### BRIEF DESCRIPTION OF DRAWINGS

FIG. 1A is a schematic diagram illustrating an automobile equipped with a HUD as an example of a movable body equipped with a display apparatus according to a first embodiment of the present invention.

FIG. 1B is a diagram illustrating an arrangement example of a projection area according to the first embodiment of the present invention.

FIG. 2 is a hardware configuration diagram of a display apparatus according to the first embodiment of the present invention.

FIG. 3 is a schematic diagram illustrating a connection relationship between the display apparatus and other electronic devices mounted on the movable body according to the first embodiment of the present invention.

FIG. 4 is a functional block diagram of an image control unit according to the first embodiment of the present invention.

FIG. 5 is a diagram illustrating an example of guide marks of a planned path according to the first embodiment of the present invention.

FIG. 6 is a diagram illustrating an example of an auxiliary image superimposed with guide marks of a planned path according to the first embodiment of the present invention.

FIG. 7 is a diagram illustrating an example of an auxiliary image superimposed with guide marks of a planned path according to the first embodiment of the present invention.

FIG. 8 is a diagram illustrating an example of an auxiliary image superimposed with guide marks of a planned path according to the first embodiment of the present invention.

FIG. 9 is a diagram illustrating an example of an auxiliary image to be superimposed with guide marks of a planned path according to the first embodiment of the present invention.

FIG. 10 is a diagram illustrating an example of an auxiliary image superimposed with guide marks of a planned path according to the first embodiment of the present invention.

FIG. 11 is a diagram illustrating an example of an auxiliary image superimposed with guide marks of a planned path according to the first embodiment of the present invention.

FIG. 12 is a diagram illustrating an example of an auxiliary image superimposed with guide marks of a planned path according to the first embodiment of the present invention.

FIG. 13 is a flowchart of a control method according to the first embodiment of the present invention.

FIG. 14 is a diagram illustrating an example of a system configuration of an autonomous driving system according to a second embodiment of the present invention.

FIG. 15 is a diagram illustrating an example of a hardware configuration of an information processing apparatus according to the second embodiment of the present invention.

FIG. 16 is a diagram illustrating an example of functional blocks of the information processing apparatus according to the second embodiment of the present invention.

FIG. 17 is a flowchart illustrating an example of processing of displaying a travel path by the information processing apparatus according to the second embodiment of the present invention.

FIG. 18A is a diagram for describing an example (part 1) of a display screen of an object indicating an autonomous travel path of a vehicle according to the second embodiment of the present invention.

FIG. 18B is a diagram for describing an example (part 1) of a display screen of an object indicating an autonomous travel path of a vehicle according to the second embodiment of the present invention.

FIG. 18C is a diagram for describing an example (part 1) of a display screen of an object indicating an autonomous travel path of a vehicle according to the second embodiment of the present invention.

FIG. 19A is a diagram for describing an example (part 2) of a display screen of an object indicating an autonomous travel path of a vehicle according to the second embodiment of the present invention.

FIG. 19B is a diagram for describing an example (part 2) of a display screen of an object indicating an autonomous travel path of the vehicle according to the second embodiment of the present invention.

FIG. 19C is a diagram for describing an example (part 2) of a display screen of an object indicating an autonomous travel path of the vehicle according to the second embodiment of the present invention.

FIG. 20A is a diagram illustrating an example of a system configuration of an autonomous driving system according to the second embodiment of the present invention.

FIG. 20B is a diagram illustrating an example of a hardware configuration of a display apparatus including the information processing apparatus according to the second embodiment of the present invention.

FIG. 21 is a diagram for describing the rotation of a vehicle about a predetermined axis according to the third embodiment of the present invention.

FIG. 22 is a diagram illustrating a configuration example of a display system in which a display apparatus is mounted according to the third embodiment of the present invention.

FIG. 23 is a schematic diagram illustrating a connection relationship between a display apparatus and other electronic devices mounted on a movable body according to the third embodiment of the present invention.

FIG. 24 is a functional block diagram of an image control unit of the display apparatus according to the third embodiment of the present invention.

FIG. 25A is a diagram illustrating an example of superimposed display of a symbol of an own vehicle in the future according to the third embodiment of the present invention.

FIG. 25B is a diagram illustrating an example of superimposed display of a symbol of an own vehicle in the future according to the third embodiment of the present invention.

FIG. 26A is a diagram illustrating an example of a superimposed display of a symbol of the own vehicle in the future according to the third embodiment of the present invention.

FIG. 26B is a diagram illustrating an example of a superimposed display of a symbol of the own vehicle in the future according to the third embodiment of the present invention.

FIG. 27A is a diagram for describing calculation of the display timing according to the change amount in the state of the own vehicle according to the third embodiment of the present invention.

FIG. 27B is a diagram for describing calculation of the display timing according to the change amount in the state of the own vehicle according to the third embodiment of the present invention.

FIG. 28 is a diagram for describing calculation of the display timing according to the change amount in the state of the own vehicle according to the third embodiment of the present invention.

FIG. 29 is a diagram illustrating an example of acquiring the change amount in the state of the own vehicle according to the third embodiment of the present invention.

FIG. 30 is a flowchart of a display control method according to the third embodiment of the present invention.

### DESCRIPTION OF EMBODIMENTS

Hereinafter, embodiments of the present invention will be described in detail with reference to the drawings.

### First Embodiment

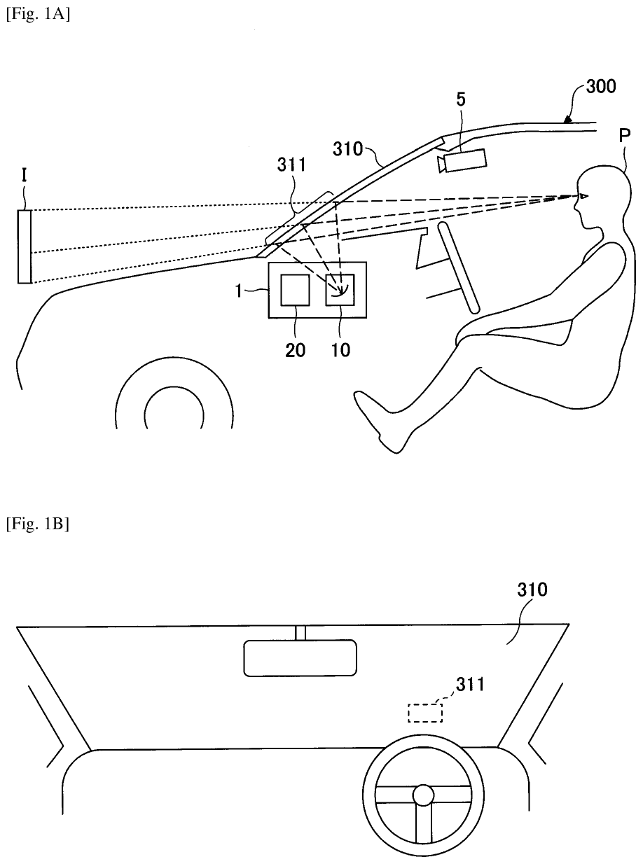

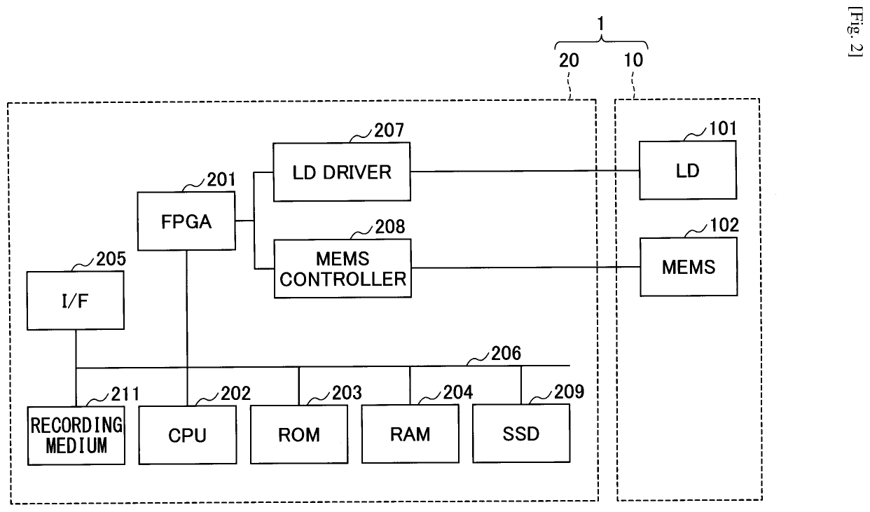

FIG. 1A schematically illustrates an automobile 300 as an example of a movable body mounted with a display apparatus 1. The display apparatus 1 is an in-vehicle head-up display (hereinafter referred to as “HUD”) in this example, but is not limited thereto. The movable body in which the display apparatus 1 is mounted is not limited to the automobile 300, and the display apparatus 1 can be mounted on a movable body, such as a vehicle, a ship, an aircraft, an industrial robot, or the like. The automobile 300 is, for example, a vehicle capable of adaptive cruise control (ACC: semi-automatic driving), and when the ACC mode is selected, the accelerator and the brakes are automatically controlled to maintain a constant distance between the own vehicle and the front vehicle.

The display apparatus 1 is mounted, for example, on a dashboard or in a dashboard of the automobile 300, and projects a light image to a predetermined projection area 311 of a windshield 310 in front of the occupant P.

The display apparatus 1 includes an optical apparatus 10 and a control apparatus 20. The control apparatus 20 primarily controls the generation and display of images projected onto the windshield 310. The optical apparatus 10 projects the generated image to the projection area 311 of the windshield 310. The configuration of the optical apparatus 10 is not illustrated in detail because the optical apparatus 10 is not directly related to the present invention, but may include, as will be described below, for example, a laser light source, an optical scanning device for two-dimensionally scanning the laser light output from the laser light source onto a screen, and a projection optical system (e.g., a concave mirror, etc.) for projecting the image light, for the intermediate image formed on the screen, onto the projection area 311 of the windshield 310. By projecting the image light to the projection area 311, the driver visually recognizes the virtual image. Note that instead of a laser light source, a screen, or a light scanning device, a light emitting diode (LED) or the like may be used as the light source, and a liquid crystal element or a Digital Mirror Device (DMD) element may be used as the image forming unit, respectively.

The projection area 311 of the windshield 310 is formed of a transmission/reflection member that reflects some parts of the light components and transmits other parts of the light components. The light image rendered by the optical apparatus 10 is reflected in the projection area 311 and directed toward the occupant P. When the reflected light enters the pupils of the occupant P in the light paths indicated by the broken lines, the occupant P visually recognizes the image projected to the projection area 311 of the windshield 310. At this time, the occupant P perceives as if the light image enters his pupils from a virtual image position I, through the light paths indicated by the dotted lines. The displayed image is recognized as if the image exists at the virtual image position I.

The virtual image at the virtual image position I is displayed in a superimposed manner on the real environment in front of the automobile 300, for example, on the traveling path. In this sense, the formed image may be referred to as an augmented reality (AR) image.

FIG. 1B is a diagram illustrating an arrangement example of the projection area 311. The projection area 311 is, for example, a relatively small area positioned slightly below the front position of the windshield 310 when viewed from the driver's seat. Line segments connecting the viewpoint of the occupant P and the virtual image position I are included in the range of the projection area 311.

The automobile 300 is equipped with a detecting device 5 for acquiring information on the surrounding environment of the automobile 300. The detecting device 5 detects objects in an external environment such as, for example, the front or the side of the automobile 300, and captures images of the detection targets as needed. The detecting device 5 may measure the vehicle-to-vehicle distance between the automobile 300 and a preceding vehicle in conjunction with the ACC mode. The detecting device 5 is an example of a sensor for acquiring external information, and includes a camera, an ultrasonic radar, a laser radar, a combination thereof, and the like.

Information may be extracted from the images acquired by the detecting device 5, such as other vehicles, artificial structures, human beings, animals, traffic signs, and the like, which are targets that may pose a hazard with respect to the traveling of the automobile 300, and may be used to determine the planned path of the embodiment.

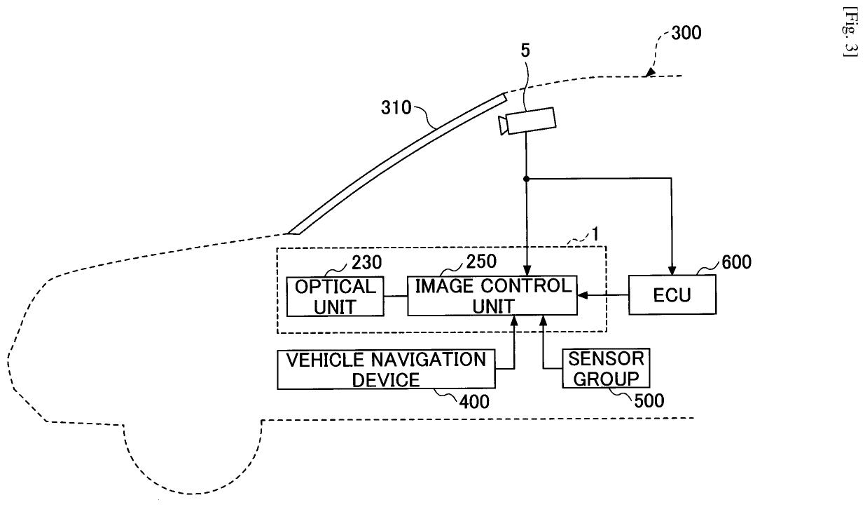

FIG. 2 is a hardware configuration example of the display apparatus 1 according to the embodiment. The optical apparatus 10 of the display apparatus 1 includes a laser diode (LD) 101 as a light source and a Micro Electro Mechanical System (MEMS) 102 as a light scanning device. The LD 101 includes, for example, laser elements that output light of red (R), green (G), and blue (B). The MEMS 102 two-dimensionally scans the laser light output from the LD 101 on a screen, to render a light image (intermediate image). The intermediate image formed on the screen is incident on the projection area 311 and is reflected toward the occupant. As the light scanning device, a polygon mirror or a galvanometer mirror, etc., may be used besides the MEMS. The screen may be formed of a micro lens array or a micro mirror array, etc.

The control apparatus 20 includes a field-programmable gate array (FPGA) 201, a central processing unit (CPU) 202, a read-only memory (ROM) 203, a random access memory (RAM) 204, an interface (hereinafter referred to as “I/F”) 205, a bus line 206, an LD driver 207, a MEMS controller 208, and a solid state drive (SSD) 209 as an auxiliary storage device. Furthermore, a recording medium 211 that can be detachably attached may be included.

The FPGA 201 controls the operation of the LD driver 207 and the MEMS controller 208. The LD driver 207 generates and outputs a drive signal for driving the LD 101 under the control of the FPGA 201. The drive signal controls the light emission timing of each of the laser elements that emit light of R, G, and B. The MEMS controller 208 generates and outputs a MEMS control signal under control of the FPGA 201, and controls the scan angle and scan timing of the MEMS 102. Instead of the FPGA 201, another logic device such as a programmable logic device (PLG) may be used.

The CPU 202 controls the overall image data processing of the display apparatus 1. The ROM 203 stores various programs including programs executed by the CPU 202 to control each function of the display apparatus 1. The RAM 204 is used as a work area of the CPU 202.

The I/F 205 is an interface for communicating with an external controller, etc., and is connected to, for example, the detecting device 5, a vehicle navigation device, and various sensor devices via a Controller Area Network (CAN) of the automobile 300.

The display apparatus 1 can read and write information in the recording medium 211 via the I/F 205. An image processing program for implementing the processing in the display apparatus 1 may be provided by the recording medium 211. In this case, the image processing program is installed in the SSD 209 from the recording medium 211 via the I/F 205. The installation of the image processing program is not necessarily performed with the recording medium 211, and may be downloaded from another computer via a network. The SSD 209 stores the installed image processing program and also stores necessary files and data.

Examples of the recording medium 211 include portable recording media such as a flexible disk, a Compact Disk Read-Only Memory (CD-ROM), a digital versatile disc (DVD), a secure digital (SD) memory card, and a Universal Serial Bus (USB) memory. Furthermore, as the auxiliary storage device, a Hard Disk Drive (HDD) or a flash memory, etc., may be used instead of the SSD 209. The auxiliary storage device such as the SDD 209 and the recording medium 211 are both computer readable recording media.

FIG. 3 is a schematic diagram illustrating the connection between the display apparatus 1 of the embodiment and other electronic devices mounted on the automobile 300. The display apparatus 1 includes an optical unit 230 and an image control unit 250. The optical unit 230 broadly corresponds to the optical apparatus 10 but may include the FPGA 201, the LD driver 207, and the MEMS controller 208 in the optical unit 230. The image control unit 250 is implemented by at least a portion of the control apparatus 20.

The image control unit 250 is connected to an electronic device such as an Electronic Control Unit (ECU) 600, a vehicle navigation device 400, a sensor group 500, and the detecting device 5 via the I/F 205 and a CAN. The image control unit 250, the vehicle navigation device 400, the sensor group 500, the ECU 600, and the detecting device 5 can communicate with each other by the CAN-BUS, and the image control unit 250 acquires external information from at least some of the interconnected devices. The image control unit 250 determines the planned path to be taken by the vehicle, and generates an object indicating the planned path as well as an auxiliary image indicating the basis for the determination. Determination of the planned path itself may be performed by the ECU 600, as will be described below. The image control unit 250 may also obtain the internal information of the automobile 300 from the ECU 600 and the sensor group 500 to generate auxiliary images representing the travelling behavior of the automobile 300 as it travels along the planned path. The generation and display of the auxiliary image will be described later with reference to FIG. 6 and onwards.

The sensor group 500 includes a steering wheel angle sensor, a tire angle sensor, an acceleration sensor, a gyro sensor, a laser radar device, a brightness sensor, and the like, to detect the behavior, the state, the surrounding state, the distance between the own vehicle and a preceding traveling vehicle, and the like. The information obtained by the sensor group 500 is supplied to the image control unit 250, and at least a portion of the sensor information is used for determining the planned path and generating the auxiliary image.

The vehicle navigation device 400 includes navigation information including road maps, GPS information, traffic control information, construction information of each road, and the like. The image control unit 250 may use at least a portion of the navigation information provided by the vehicle navigation device 400 to determine the planned path.

The detecting device 5 may be a monocular camera, a stereo camera, an omnidirectional camera, or a remote sensing device using Light Detection and Ranging (LiDAR). The detecting device 5 detects the situation of the road, a vehicle ahead, a bicycle, a human being, a sign, etc. The information acquired by the detecting device 5 is supplied to the image control unit 250 and the ECU 600, and at least a part of the detection information is used for determining the planned path.

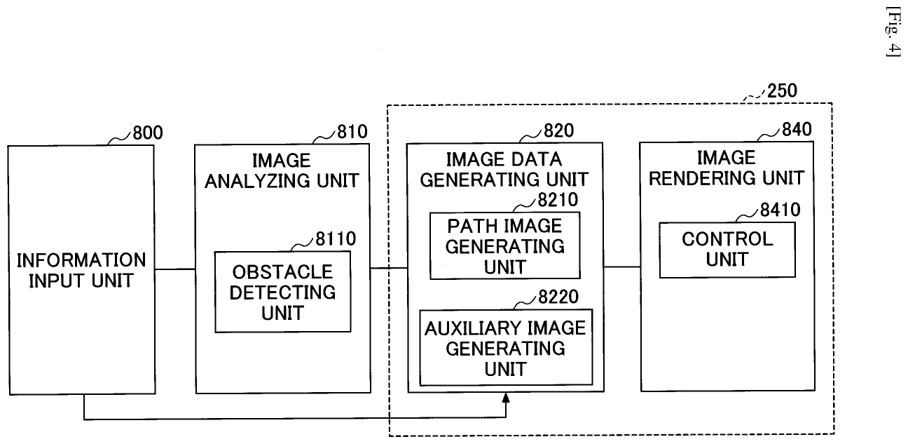

FIG. 4 is a functional block diagram of the image control unit 250. The image control unit 250 includes an image data generating unit 820 and an image rendering unit 840. The image data generating unit 820 includes a path image generating unit 8210 and an auxiliary image generating unit 8220. The image data generating unit 820 generates a path image and an auxiliary image based on information input from an information input unit 800 and an image analyzing unit 810. In FIG. 4, as a matter of convenience, the path image generating unit 8210 and the auxiliary image generating unit 8220 are depicted as separate blocks, but the path image and the auxiliary image may be generated simultaneously by the same function.

The information input unit 800 is implemented, for example, by the ECU 600, and inputs information from the vehicle navigation device 400, the sensor group 500, and the detecting device 5. The information input unit 800 receives internal information including, for example, the steering wheel angle, the present speed, and the direction of the tires of the automobile 300, through the CAN or the like from the sensor group 500. In addition, detection information and navigation information are received from the detecting device 5 and the vehicle navigation device 400, respectively.

The image analyzing unit 810 includes an obstacle detecting unit 8110, and extracts, from the detection information, obstacles such as a person, an object, or another vehicle that obstructs the travelling of the vehicle. The image analyzing unit 810 may be implemented, for example, by the ECU 600.

The image data generating unit 820 generates a planned path that is displayed in a superimposed manner on the surrounding environment (travelling road surface, etc.), and an auxiliary image as necessary, based on the information obtained by the information input unit 800 and the analysis result by the image analyzing unit 810.

The image rendering unit 840 includes a control unit 8410 for controlling the operations of the optical apparatus 10 based on the image data generated by the image data generating unit 820. The image rendering unit 840 may be implemented by the FPGA 201, the LD driver 207, and the MEMS controller 208.

The functional configuration of FIG. 4 is an example, and when the information input unit 800 and the image analyzing unit 810 are implemented by the ECU 600, the ECU 600 may generate the planned path based on information from the vehicle navigation device 400, the detecting device 5, the sensor group 500, or the like. In this case, the external information related to the generation of the planned path may be input to the auxiliary image generating unit 8220 of the image data generating unit 820.

The information input unit 800 and the image analyzing unit 810 may be included in the image control unit 250. In this case, the image control unit 250 may detect obstacles based on information from the vehicle navigation device 400, the detecting device 5, the sensor group 500, or the like and generate the planned path and the auxiliary image.

Hereinafter, a specific example of the planned path and the auxiliary image will be described. While the following description assumes that the automobile 300 is travelling in the ACC mode, the control technique of the present invention is also applicable to display control during manual driving.

<Example of Planned Path and Auxiliary Image>

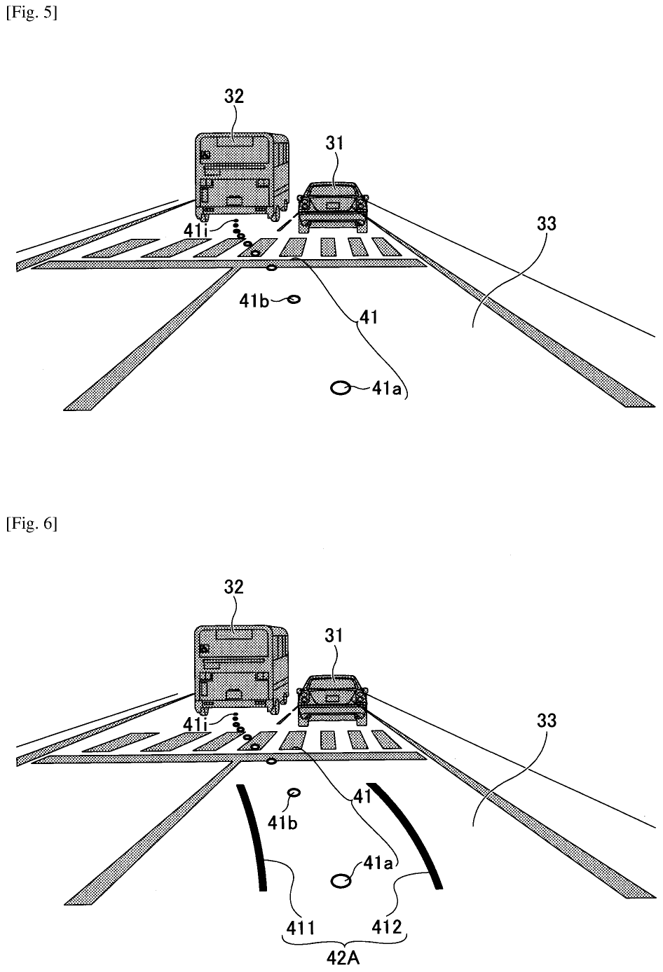

FIG. 5 is an example of guidance marks 41 illustrating the planned path of the automobile 300. FIG. 5 illustrates a standard-sized vehicle 31 travelling in front of the own vehicle traveling on the right lane on a two-lane road, and a bus 32 travelling ahead on the left lane. The display apparatus 1 detects that the own vehicle will turn left at a traffic light ahead, for example, based on information acquired from the vehicle navigation device 400, and generates and displays the guidance marks 41 indicating the planned path to enter the left lane. The display apparatus 1 may determine the timing of generating and outputting the guidance marks 41, by detecting the present vehicle speed and position based on the internal information of the own vehicle acquired from the sensor group 500.

The guidance marks 41 are formed by a plurality of circles 41a-41i as an example, and the circles 41a-41i are arranged in a perspective manner from the front, such that the sizes become gradually smaller and the intervals become narrower, obliquely upward to the left. Such guidance marks 41 may be stored in advance as object data in the ROM 203 or the like. The light image of the guidance marks 41 is actually formed by two-dimensionally scanning the laser light into the predetermined projection area 311 illustrated in FIG. 1B, and when viewed from the occupant's perspective, the guidance marks 41 are displayed in a superimposed manner on a traveling path 33 ahead.

By displaying the guidance marks 41 of the planned path, the occupant can predict the path of his or her own vehicle, thereby increasing his or her sense of security during automatic driving. In the embodiment, an auxiliary image, which further enhances the sense of security, is also displayed in a superimposed manner together with the guidance marks 41.

FIG. 6 illustrates an example of an auxiliary image 42A that is displayed in a superimposed manner with the guidance marks 41. As the auxiliary image 42A, trajectories 411 and 412 of the tires of the own vehicle are displayed by two lines. The occupant can recognize the planned path by the guidance marks 41, and can use the automatic driving function with a sense of security to predict how the own vehicle will move.

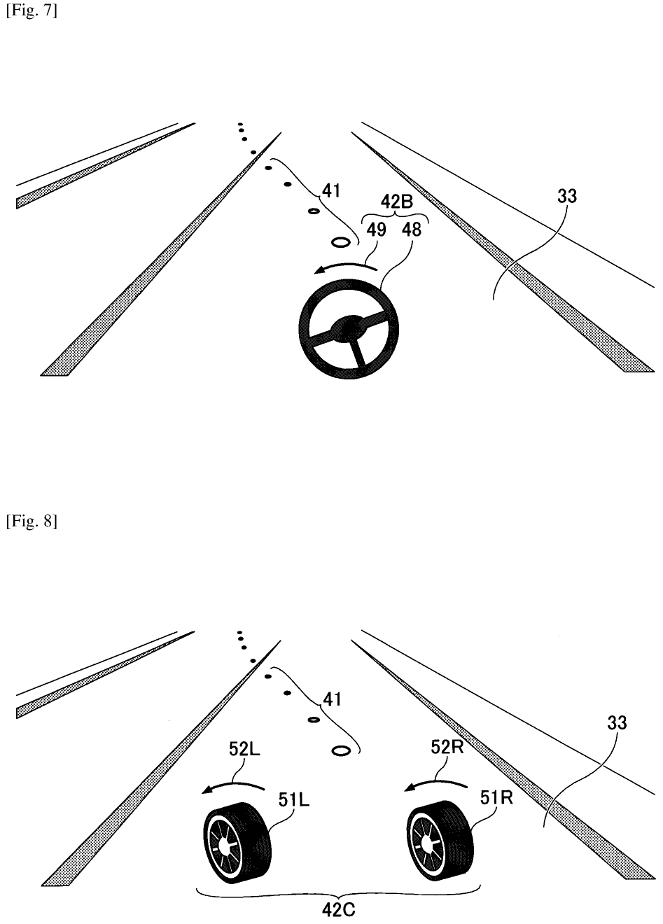

FIG. 7 illustrates an auxiliary image 42B indicating the operation of the steering wheel with the guidance marks 41 illustrating the planned path. The auxiliary image 42B is formed of a steering wheel 48 and an arrow 49. FIG. 7 illustrates that the steering wheel is turned to the left, in the direction of the arrow 49 of the steering wheel 48.

The image control unit 250 may acquire calculation information on to what angle the steering wheel rotates in the case of proceeding in the planned path, from the ECU 600 associated with the ACC function, to generate image data of the steering wheel 48. Alternatively, steering wheel angle information may be obtained from the sensor group 500, to generate and display in a superimposed manner, image data of the steering wheel 48 in an approximately real time manner. An object of the steering wheel 48 and the arrow 49 may be stored in the ROM 203 or the like in advance, and the image data may be adjusted according to the calculation result.

In general specifications, the steering wheel moves automatically during automatic driving; however, by displaying, in a superimposed manner, the auxiliary image 42 of the steering wheel operation on the traveling path along with the guidance marks 41, the occupant can intuitively recognize the traveling path and the behavior of the vehicle at the same time.

FIG. 8 illustrates an auxiliary image 42C indicating the tire orientation with the guidance marks 41 indicating the planned path. The auxiliary image 42C is formed of a pair of tires 51L and 51R and arrows 52L and 52R indicating the angles of the respective tires. With the tires 51L and 51R and the arrows 52L and 52R, the occupant can intuitively recognize that the own vehicle will be traveling to the left.

The image control unit 250 may acquire the calculation information of to what angle the tire will change direction when travelling on the planned path, from the ECU 600 associated with the ACC function, and generate image data of the tires 51R and 51L. Alternatively, the tire angle information may be obtained from the sensor group 500 to generate image data of the tires 51R and 51L and display the image data in a superimposed manner in approximately real time. A method of storing objects of the tires 51R and 51L and the arrows 52R and 52L in advance in the ROM 203 or the like and adjusting the image data according to the calculation result may be used.

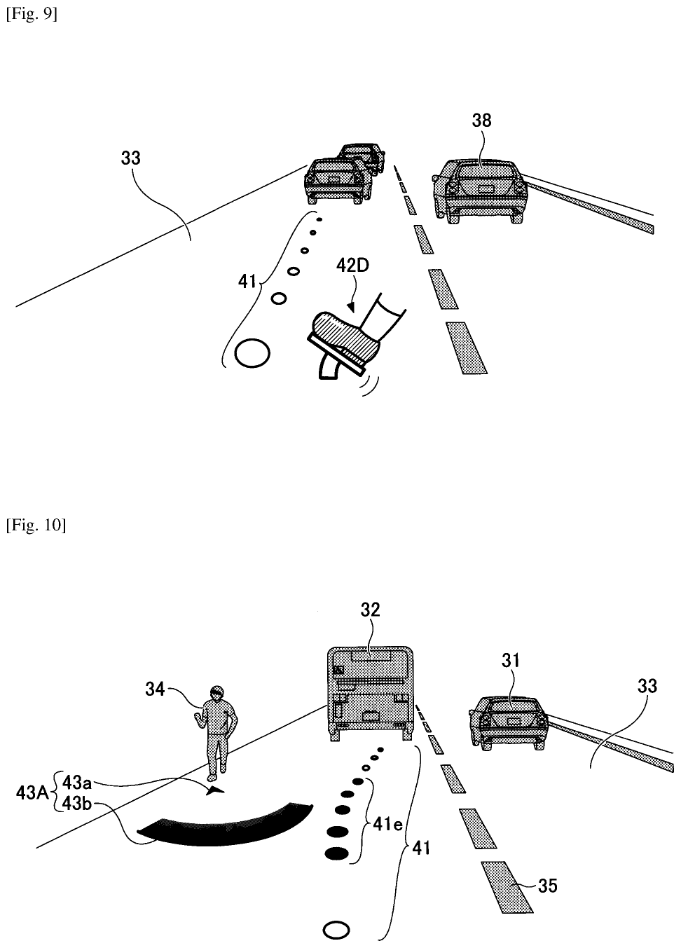

FIG. 9 illustrates an example of superimposed display of an auxiliary image 42D representing a brake pedal displayed in a superimposed manner together with guidance marks 41 illustrating a planned path. The guidance marks 41 are displayed in a superimposed manner to indicate a path of travelling on the present lane. When traffic congestion is detected in the forward direction and another vehicle 38 is detected in the right lane, the speed of the own vehicle travelling automatically, is decelerated. At this time, by displaying in a superimposed manner the auxiliary image 42D of the brake pedal with the guidance marks 41, the occupant can easily recognize the behavior of the vehicle and continue the automatic driving with a sense of security.

FIG. 10 illustrates the planned path and the auxiliary image displayed in another situation. In FIGS. 6 to 9, as a result of the determination of the planned path, the motion performed by the own vehicle is illustrated in the auxiliary images 42A to 42D. In FIG. 10, the basis for the determination of the selection of the planned path is indicated by an auxiliary image.

The automobile 300 travels on the left lane of a two-lane road, and the bus 32 travels in front of the own vehicle. The standard-sized vehicle 31 travels ahead on the right lane. A person 34 is jogging on the left road shoulder as viewed from the own vehicle. At this time, the guidance marks 41 are generated indicating to travel closer to a center white line 35 as the planned path, and the guidance marks 41 are displayed in a superimposed manner on the traveling path 33.

Along with the guidance marks 41, an auxiliary image 43A indicating the basis for determining the planned path is displayed in a superimposed manner on the traveling path 33. The auxiliary image 43A is an image that highlights the presence of the person 34 jogging travelling on the left road shoulder, including, for example, an arrow 43a indicating the person 34 and an area line 43b indicating a certain range from the person 34. This auxiliary image 43A may be highlighted to alert the occupant, or may be displayed in a different color than guidance marks 41.

Also, at least a portion of the guidance marks 41 may be highlighted. For example, the portions of the guidance marks 41 indicating to avoid the person 34 and to move towards the white line 35, may be represented with highlighted marks 41e.

The auxiliary image 43A may be generated and displayed to provide a basis for the presence of an obstacle or the like, but the planned path has not been changed. For example, if the traveling position of the automobile 300 is sufficiently distant from the road shoulder where the person 34 is jogging, the auxiliary image 43A or an image representing the person 34 may be generated and displayed in a superimposed manner on the front road surface, without generating the guidance marks 41. The occupant of the automobile 300 recognizes that there is an obstacle on the road but that the present driving position may be maintained, and thereby feel a sense of security.

The image control unit 250 acquires the imaging information for each predetermined frame, for example, from the detecting device 5, analyzes the imaging information, and monitors whether an image representing an obstacle is included. If the imaging information includes an image indicating an obstacle, the image control unit 250 identifies the position of the obstacle and determines the planned path from the position, the speed, etc. of the own vehicle. In the example of FIG. 10, the presence of the person 34 is detected, and the guidance marks 41 indicating the planned path to avoid the left road shoulder are generated, and the auxiliary image 43A indicating the presence of the person 34 is generated.

The light images of the guidance marks 41 and the auxiliary image 43A are projected within the range of the projection area 311 illustrated in FIG. 1B, and are reflected in the direction of the occupant. The occupant visually recognizes the guidance marks 41 and the auxiliary image 43A formed at the virtual image position I being displayed in a superimposed manner on the traveling path 33. The basis for taking the planned path is presented, and, therefore, the occupant can easily assume the behavior of the own vehicle and maintain a sense of security even during automatic driving.

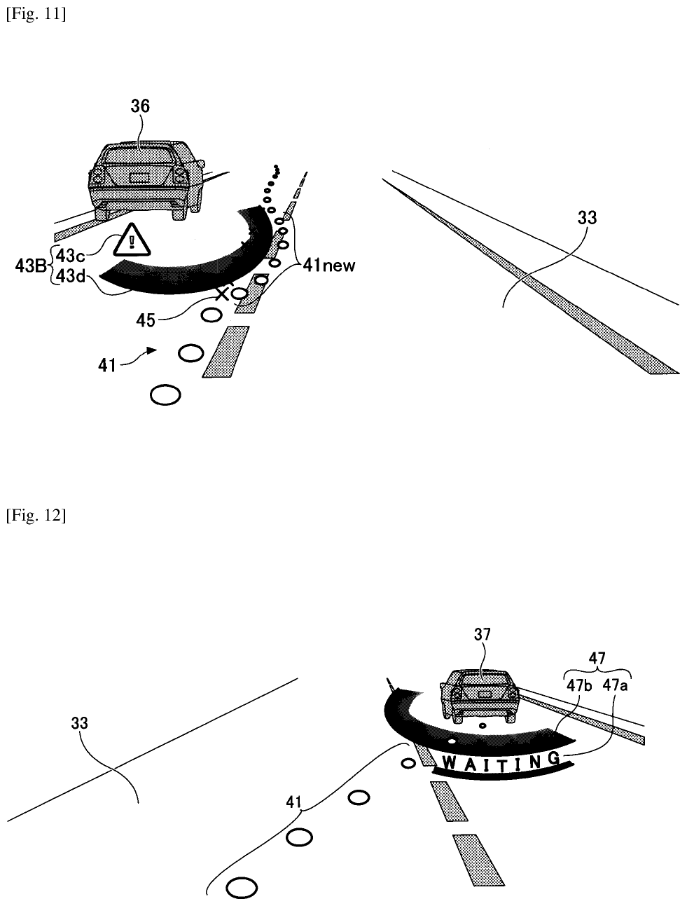

FIG. 11 is a diagram illustrating another example of an auxiliary image indicating the basis for determining the planned path. FIG. 11 illustrates an example of a path change due to the detection of an obstacle after displaying, in a superimposed manner, the planned path. The automobile 300 is travelling on the travel path 33. At this time, the guidance marks 41 arranged in a straight line are displayed in a superimposed manner on the traveling path 33, as a planned path.

When a vehicle 36 stopping on the road shoulder on the left side as viewed from the own vehicle is detected while traveling, the image control unit 250 generates image data for changing the planned path and outputs the image data. Initially, a straight path has been presented as indicated by cross marks 45, but to avoid the stopping vehicle 36, guidance marks 41new indicating a new planned path to bypass to the right, are generated.

Together with the updating of the guidance marks 41new, an auxiliary image 43B indicating the basis for determining the path change is generated and displayed in a superimposed manner on the traveling path 33. For example, the auxiliary image 43B includes a triangular stop plate 43c and an area line 43d indicating a range from the vehicle 36 being stopped. Such auxiliary images 43B may be highlighted to alert the occupant or displayed in a different color from the guidance marks 41.

The image control unit 250 acquires the detection information or the imaging information for each predetermined frame, for example, from the detecting device 5, analyzes the detection information, and monitors whether an image representing an obstacle is included. When the detection information includes an image indicating an obstacle, the image control unit 250 identifies the position of the obstacle and determines the planned path based on the position, the speed, etc., of the own vehicle. In the example of FIG. 10, the presence of the vehicle 36 being stopped is detected, and the guidance marks 41new indicating the planned path after the change to avoid the left road shoulder are generated, and the auxiliary image 43B indicating the presence of the vehicle 36 being stopped is generated.

As a planned path, the path proceeding straight ahead before being changed may be displayed in a superimposed manner with cross marks 45, together with the guidance marks 41new after updating the planned path. The occupant can intuitively recognize the difference between the path before being changed and the path after being changed, making it easier to predict the behavior of the own vehicle even during automatic driving.

FIG. 12 illustrates a view of the planned path and the auxiliary image in another situation. The automobile 300 is travelling on the left lane of two lanes of the road and is going to change the lane to the right lane. The image control unit 250 generates and outputs guidance marks 41 indicating a route to change lanes to the right lane at a predetermined timing, based on information acquired, for example, from the vehicle navigation device 400, and the speed and the position of the own vehicle.

At this time, when another vehicle 37 traveling on the right lane is detected, an auxiliary image 47 indicating “waiting” for the lane change to the right lane is displayed in a superimposed manner while the guidance marks 41 indicating the planned path are maintained as is. In the example of FIG. 12, the auxiliary image 47 is formed of a character object 47a of “WAITING” and a highlight 47b, but is not limited to this example and may be, for example, an image object of a palm of a hand.

When the vehicle 37 is no longer detected within a predetermined range around the own vehicle, the superimposed display of the auxiliary image 47 is terminated, and the vehicle changes the lane in accordance with the guidance marks 41.

The occupant can recognize in advance that the vehicle will change lanes to the right lane, and intuitively recognize that the own vehicle cannot immediately change lanes due to the presence of another vehicle 37 on the right lane. Therefore, the behavior of the own vehicle can be easily predicted in advance, and automatic driving can be continued with a sense of security.

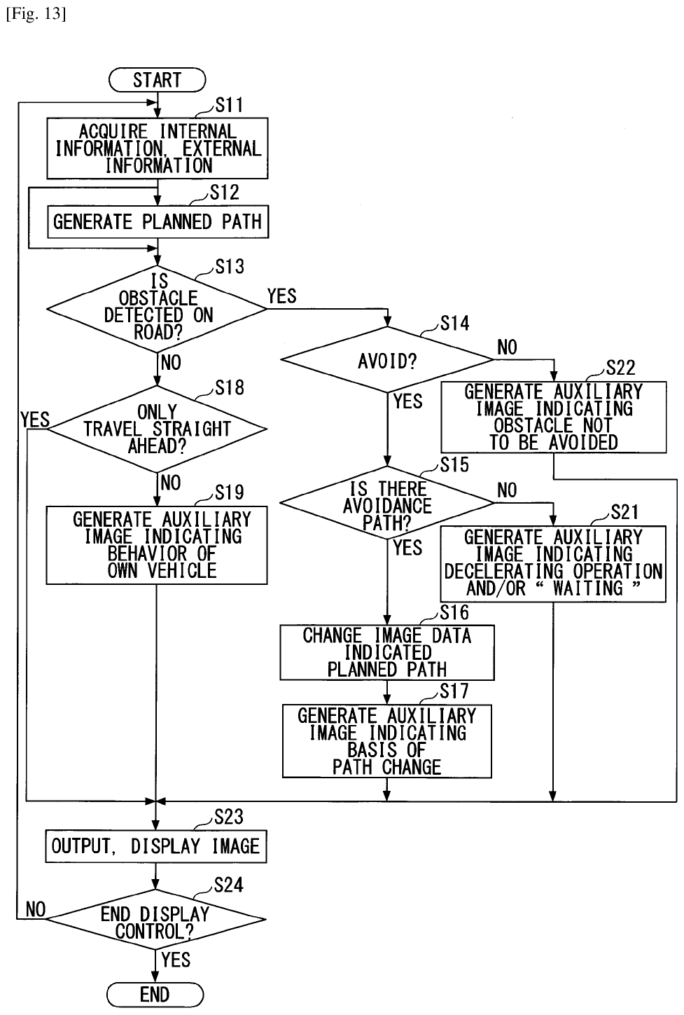

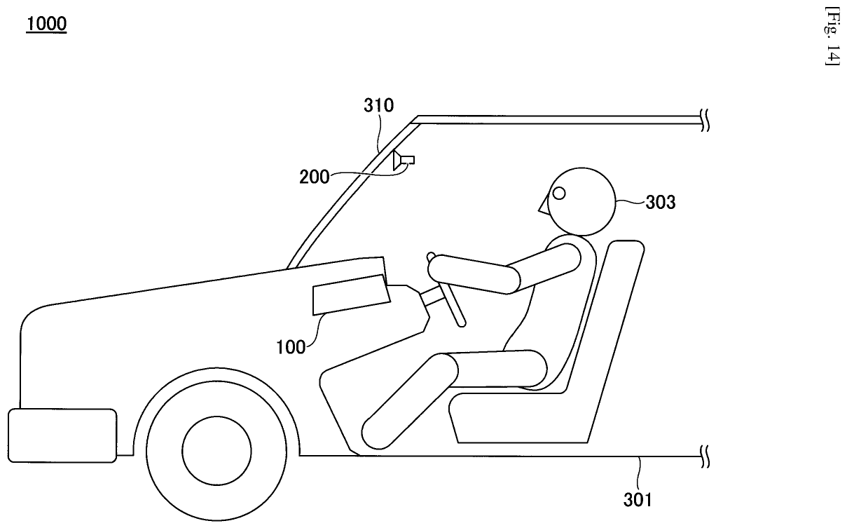

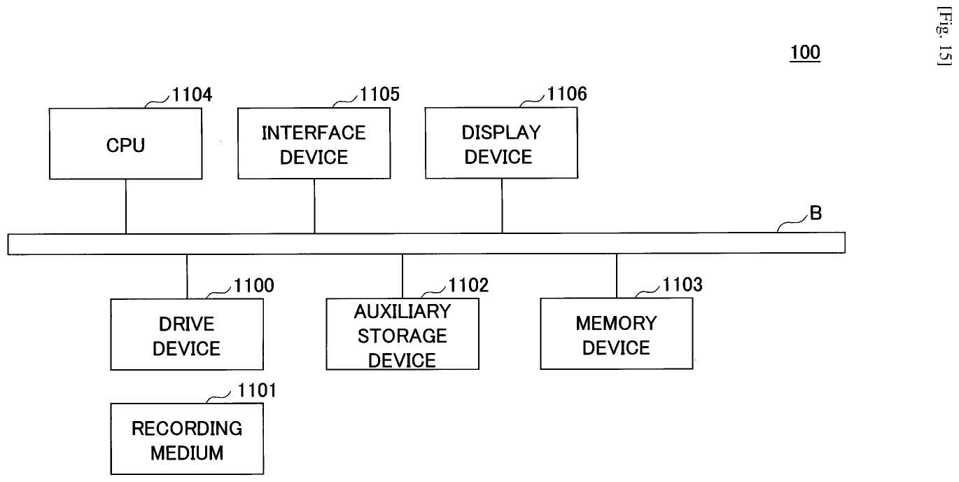

FIG. 13 is a flow chart of display control performed by the image control unit 250.

The image control unit 250 acquires the internal information and the external information of the own vehicle (step S11). Internal information includes speed information, steering wheel angle information, tire angle information, and position information estimated by the vehicle, obtained from the sensor group 500 and the ECU 600. External information includes map information, imaging information, surrounding environmental information, and ranging information obtained from the vehicle navigation device 400, the detecting device 5, the sensor group 500 (laser radar, etc.), GPS, etc.

The image control unit 250 generates a planned path based on the acquired information (step S12). The internal information and the external information are constantly acquired, and the image control unit 250 determines whether an obstacle is detected on the planned path (step S13).

When an obstacle is detected (YES in step S13), the image control unit 250 determines whether to avoid the obstacle (step S14). If the obstacle is not to be avoided (NO in S14), an auxiliary image representing an obstacle that will not be avoided is generated (step S22) and the generated image is output (step S23). A case of not avoiding an obstacle, for example, is when there is sufficient space between the vehicle and the obstacle, the speed of the vehicle is low enough to ensure safety, and so on. Although the obstacle is not to be avoided, indicating the presence of the obstacle gives the occupant of the movable body a sense of security by recognizing the situation in the surrounding environment.

When the detected obstacle is to be avoided (YES in S14), the image control unit 250 determines whether there is an avoidance path (step S15). When it is determined that there is a path to avoid the obstacle by changing lanes, etc. (YES in step S15), the image data of the guidance marks 41 indicating the planned path is changed (step S16). For example, a planned path to proceed straight ahead is changed to a curved path that represents a diversion or lane change. The image control unit 250 generates an auxiliary image indicating the basis of the path change along with the change of the planned path (step S17). The auxiliary image may be, for example, a highlighted image indicating the presence of the obstacle and a certain range around the obstacle. The pieces of data of the changed planned path and the auxiliary image are output and displayed in a superimposed manner (step S23).

When there is no avoidance path (NO in step S14), the image control unit 250 maintains the generated planned path and generates an auxiliary image indicating a deceleration operation and/or “WAITING” (step S21). The pieces of data of the planned path and the auxiliary image are output and displayed in a superimposed manner (step S23).

When an obstacle is not detected on the path in step S13, it is determined whether the planned path is proceeding straight ahead only (step S18). When there is an element other than proceeding straight ahead, such as a lane change, a right or left turn, or the like, is included, the image control unit 250 generates an auxiliary image indicating the behavior of the own vehicle (step S19). The auxiliary image may be a steering wheel operation, the tire orientation, the trajectory, etc. The pieces of data of the generated planned path and the auxiliary image are output and displayed in a superimposed manner (step S23).

When the generated path is proceeding straight ahead only, the image data of the planned path is output and displayed in a superimposed manner (step S23). Steps S11 to S23 are repeated until the display control ends (NO in step S24). When the vehicle finishes travelling (when the engine is turned off), the display control is ended (YES in step S24) and the procedure is ended.

When this control is executed by a program, the control program may be stored in the ROM 203 or the SSD 209, and the program may be read out and executed by the CPU 202. In this case, the CPU 202 executes at least the following procedure: (a) A procedure for generating data of an image indicating an object, other than the movable body, concerning the determining of the planned path of the vehicle (i.e., the movable body), based on the information of the object concerning the determining of the planned path.

The present invention is not limited to the embodiments described above. For example, an auxiliary image may be displayed in a superimposed manner, combining both the basis for determining the planned path and the behavior of the own vehicle when proceeding along the planned path. As illustrated in FIGS. 6 to 9, the trajectories of the tires of the own vehicle, the movement of the steering wheel, and the like, may be displayed in a superimposed manner as auxiliary images. As illustrated in FIGS. 10 to 12, auxiliary images may be displayed in a superimposed manner to highlight an obstacle such as a pedestrian on the road shoulder, a vehicle being stopped, and the like, by surrounding the obstacle with a circle.

The control apparatus that generates image data that is displayed in a superimposed manner on the environment around the movable body, may have a configuration including an image data generating unit that generates, as image data, a path image representing a planned path of the movable body; and an auxiliary image representing the behavior of the movable body as the movable body proceeds along the planned path.

The behavior of the own vehicle displayed in a superimposed manner together with the guidance marks 41 of the planned path, is not limited to the operation of the tires, the steering wheel, or the like. For example, in place of the steering wheel, the tire, or the like, the operation of other parts, such as a blinking image of a blinker, may be displayed in a superimposed manner.

As the optical apparatus 10, a panel method may be adopted instead of the laser scanning method. As the panel method, an imaging device such as a liquid crystal panel Digital Mirror Device (DMD) panel, a Vacuum Fluorescent Display (VFD), etc., may be used.

The projection area 311 of the windshield 310 may be provided with a combiner formed of a half-silvered mirror (half mirror, semitransparent mirror) or a hologram, etc. A light transmission or reflection type reflection film may be vapor-deposited on the surface of or between the layers of the windshield 310.

At least a part of each function of the display apparatus 1 may be implemented by cloud computing configured of one or more computers.

### Second Embodiment

<System Configuration>

First, the system configuration of the autonomous driving system 1000 according to the present embodiment will be described with reference to FIG. 14. FIG. 14 is a diagram illustrating an example of a system configuration of an autonomous driving system 1000 according to the embodiment.

As illustrated in FIG. 14, the autonomous driving system 1000 according to the embodiment is mounted in a movable body such as a vehicle, a ship, an aircraft, a personal mobility, and an industrial robot, that is a movable body that travels autonomously (automatic driving). The autonomous driving system 1000 includes an information processing apparatus 100 and a sensor 200. In the following, an example in which the autonomous driving system 1000 is mounted in a vehicle is described. However, the autonomous driving system 1000 can also be applied to a movable body other than a vehicle. Vehicles include, for example, automobiles, motorized bicycles, light vehicles, and railway vehicles.

The information processing apparatus 100 is, for example, an Electronic Control Unit (ECU) that electronically controls various devices such as a steering wheel, a brake, and an accelerator of a vehicle 301. The information processing apparatus 100 causes the vehicle 301 to autonomously drive to a predetermined destination in accordance with the external environment of the vehicle 301 detected by the sensor 200. The autonomous driving includes, for example, not only driving by completely automatic driving, but also driving by an occupant constantly monitoring the driving conditions of the vehicle 301 and manually operating as necessary.

The sensor 200 is a sensor such as a camera, GPS, radar, and LIDAR to detect objects in front of (traveling direction) of the vehicle 301 and the present position of the vehicle 301.

<Hardware Configuration>

Next, the hardware configuration of the information processing apparatus 100 according to this embodiment will be described with reference to FIG. 15. FIG. 15 is a diagram illustrating an example of a hardware configuration of the information processing apparatus 100 according to an embodiment.

The information processing apparatus 100 according to an embodiment includes a drive device 1100, an auxiliary storage device 1102, a memory device 1103, a CPU 1104, an interface device 1105, a display device 1106, and an input device 1107, respectively, which are interconnected by a bus B, as illustrated in FIG. 15.

A program for implementing processing by the information processing apparatus 100 is provided by a recording medium 1101. When the recording medium 1101 recording the program is set in the drive device 1100, the program is installed in the auxiliary storage device 1102 from the recording medium 1101 through the drive device 1100. However, it is not necessary to install the program from the recording medium 1101, and may be downloaded from other computers via the network. The auxiliary storage device 1102 stores the installed program and stores the necessary files, data, and the like. An example of the recording medium 1101 includes a portable recording medium such as a CD-ROM, a DVD disk, or a USB (Universal Serial Bus) memory. An example of the auxiliary storage device 1102 includes a hard disk drive (HDD) or a flash memory. Both the recording medium 1101 and the auxiliary storage device 1102 correspond to a computer readable recording medium.

The memory device 1103 reads out the program from the auxiliary storage device 1102 and stores the program when the program startup instruction is received. The CPU (Central Processing Unit) 104 implements the functions pertaining to the information processing apparatus 100 according to a program stored in the memory device 1103. The interface device 1105 is an interface for communicating with an external controller or the like and is connected to a vehicle navigation device, various sensor devices, or the like, for example, via the CAN of the vehicle 301. The sensor 200 is also connected to the interface device 1105.

The display device 1106 displays a programmed GUI (Graphical User Interface) or the like. The display device 1106 is, for example, a display device such as a head-up display (HUD, Head-Up Display), an instrument panel, a center display, and a head mounted display (Head Mounted Display). The head-up display is a device that reflects the projected light from the light source onto the windshield or the combiner of the vehicle 301 for display. The instrument panel is a display device disposed on a dashboard or the like located in front of the vehicle 301. The center display is, for example, a display device disposed in a traveling direction of the vehicle 301 from the viewpoint of the occupant.

<Functional Configuration>

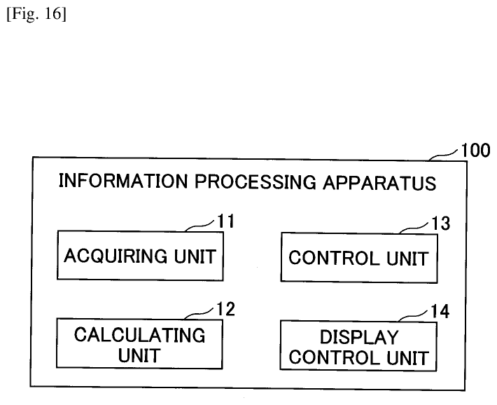

Next, the functional configuration of the information processing apparatus 100 according to the embodiment will be described with reference to FIG. 16. FIG. 16 is a diagram illustrating an example of functional blocks of the information processing apparatus 100 according to an embodiment.

The information processing apparatus 100 includes an acquiring unit 11, a calculating unit 12, a control unit 13, and a display control unit 14. Each of these units is implemented by a process in which one or more programs installed in the information processing apparatus 100 are executed in the CPU 1104 of the information processing apparatus 100.

The acquiring unit 11 acquires an image, etc., of the front of the vehicle 301, etc., captured by the sensor 200.

The calculating unit 12 calculates the autonomous travel path from the present position of the vehicle 301 to the predetermined destination (the route) at any time based on the information of the external environment of the vehicle 301 acquired from the sensor 200 by the acquiring unit 11.

The control unit 13 controls various devices of the vehicle 301 based on the information of the external environment of the vehicle 301 acquired from the sensor 200 by the acquiring unit 11, and causes the vehicle 301 to travel along the travel path calculated by the calculating unit 12.

The display control unit 14 causes the display device 1106 to display an object representing an autonomous travel path of the vehicle 301 calculated by the calculating unit 12.

### <Process>

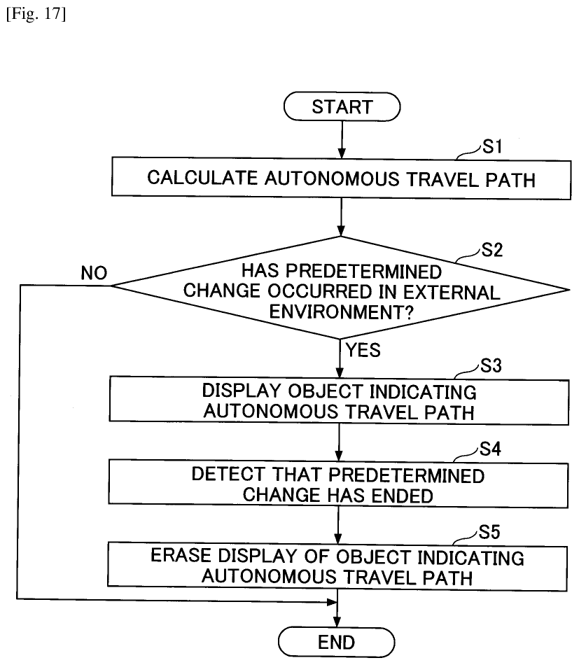

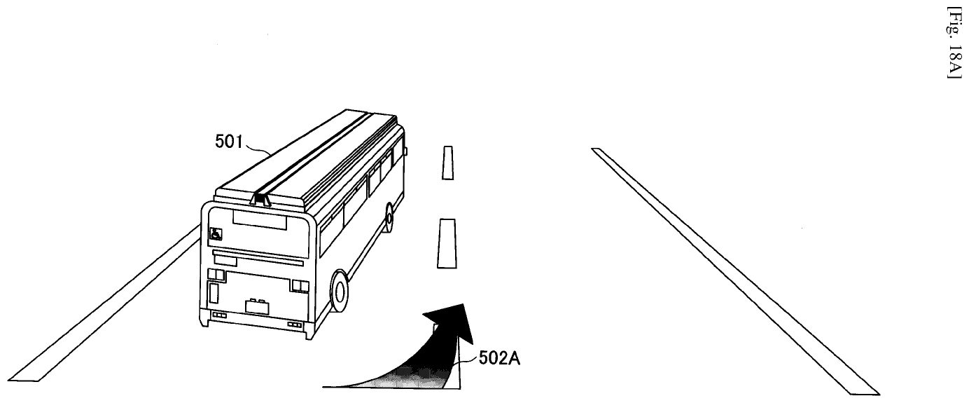

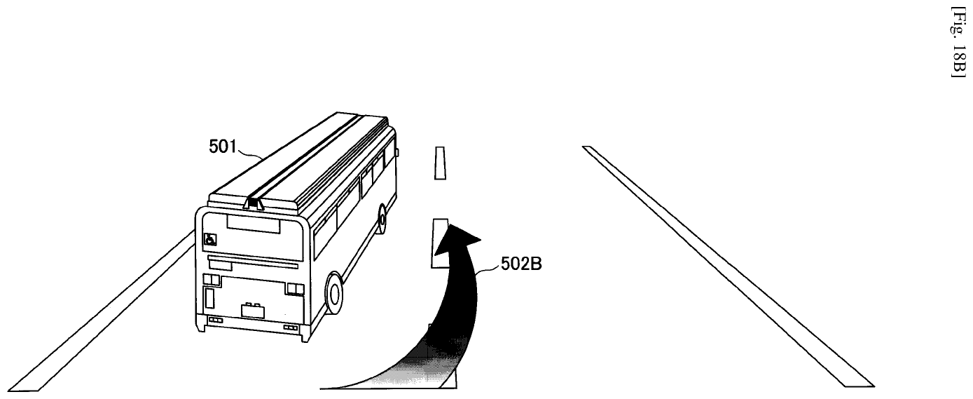

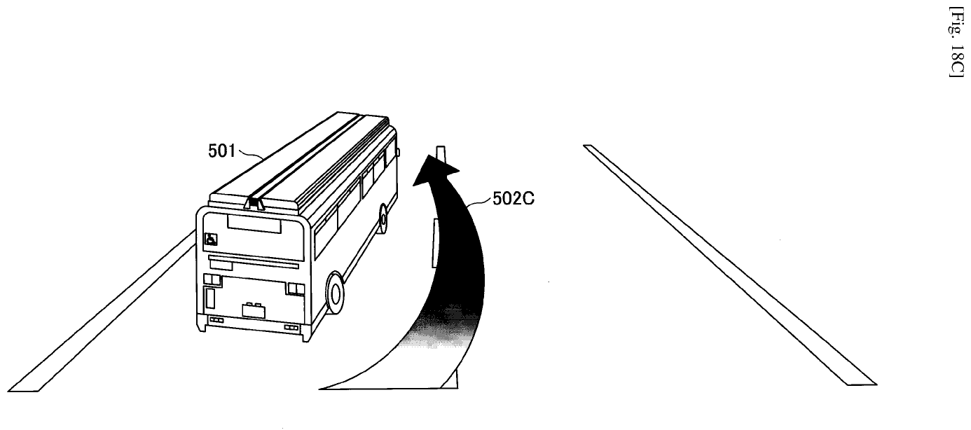

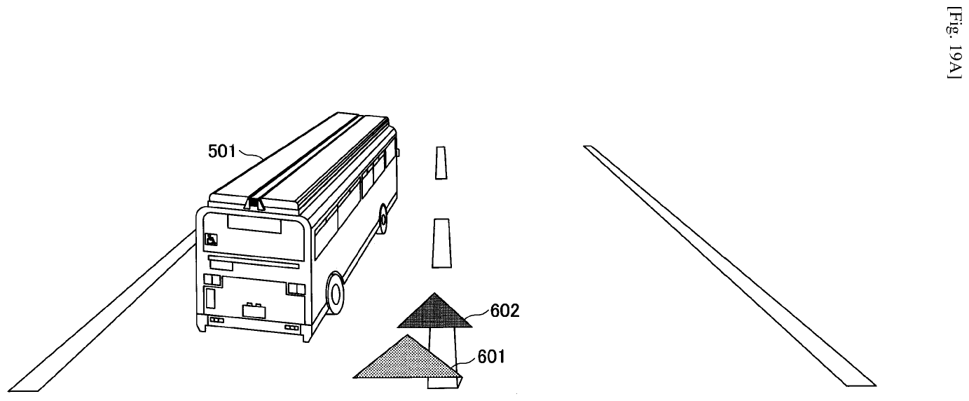

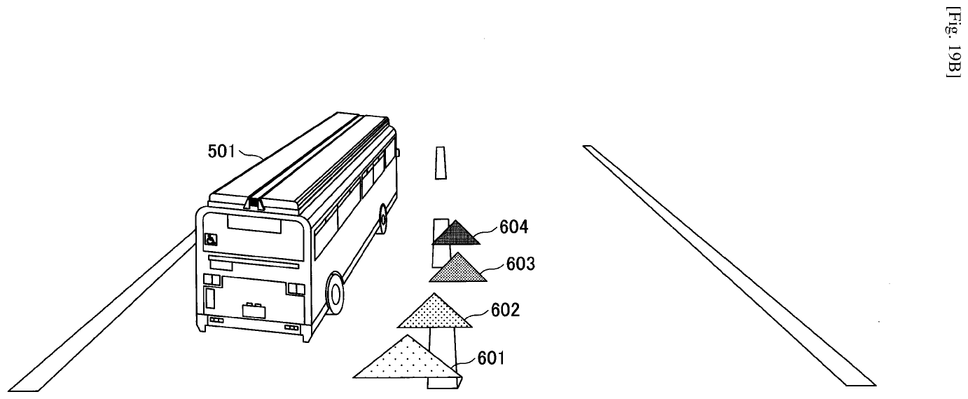

Next, a process of displaying a travel path by the information processing apparatus 100 according to the embodiment will be described with reference to FIGS. 17 to 19C. FIG. 17 is a flowchart illustrating an example of a process for displaying a travel path by the information processing apparatus 100 according to the embodiment. FIGS. 18A through 18C are diagrams illustrating an example (part 1) of an object display screen indicating an autonomous travel path of the vehicle 301. FIGS. 19A through 19C are diagrams illustrating an example (part 2) of an object display screen indicating an autonomous travel path of the vehicle 301.

The processing of FIG. 17 may be performed at predetermined intervals such as, for example, each time the sensor 200 measures information about the external environment of the vehicle 301, or 30 times per second.

In step S1, the calculating unit 12 calculates the autonomous travel path in the path from the present position of the vehicle 301 to a predetermined destination, based on the information of the external environment of the vehicle 301 acquired from the sensor 200 by the acquiring unit 11. Here, for example, the calculating unit 12 calculates an autonomous travel path from the present position of the vehicle 301 to a point at a predetermined distance (e.g., 200 m) in the path.

Subsequently, in step S2, the control unit 13 determines whether there has been a predetermined change in the external environment of the vehicle 301, based on the information of the external environment of the vehicle 301 acquired from the sensor 200 by the acquiring unit 11. Here, the control unit 13 may determine that the predetermined change has occurred when, for example, a situation in which the direction of autonomous movement or acceleration of the vehicle 301 is to be changed by a predetermined threshold or more by changing the present control content for various devices such as the steering wheel, the brake, and the accelerator, due to a change in the external environment of the vehicle 301 by a certain amount or more. In this case, the control unit 13 may determine that the predetermined change in the external environment of the vehicle 301 has occurred, for example, when the following conditions have been detected.

The control unit 13 may, for example, determine that the predetermined change in the environment outside the vehicle 301 has occurred when there is a situation in which a temporary lane change or the like is to be performed to avoid an obstacle due to the detection of an obstacle such as a pedestrian and other vehicles that are stopping in front of the vehicle 301.

The control unit 13 may also determine that the predetermined change has occurred in the external environment of the vehicle 301, for example, when the present position of the vehicle 301 reaches a point in front of a predetermined distance (e.g., 100 m) from an intersection or interchange where a right turn, left turn, or lane change, etc., is to be made on the path to the destination.

The control unit 13 may also determine that the predetermined change has occurred in the external environment of the vehicle 301, for example, when the front intersection of the vehicle 301 is a red signal and the vehicle 301 needs to stop. In this case, the calculating unit 12 may calculate an autonomous travel path from the present position of the vehicle 301 to the point where the vehicle 301 is expected to stop, and when the signal turns green, the calculating unit 12 may calculate an autonomous travel path from the position of the vehicle 301 at that time point. Accordingly, the occupant can recognize that the vehicle 301 will perform a brake operation by viewing the display by the information processing apparatus 100.

When the predetermined change has not occurred in the external environment of the vehicle 301 (NO in step S2), the process is ended. Meanwhile, when the predetermined change has occurred (YES in step S2), in step S3, the display control unit 14 displays an object representing the autonomous travel path of the vehicle 301 calculated by the calculating unit 12.

In the example of FIGS. 18A-18C, the display control unit 14 sequentially displays an object 502A-object 502C indicating a travel path that protrudes into the opposing lane and overpasses a vehicle 501 and returns to the original lane, because the other vehicle 501 stops in front of the vehicle 301 while the vehicle 301 autonomously travels on a road with one lane on one side.

When the display control unit 14 detects that the control unit 13 has determined that it is a situation where a temporary lane change is to be performed in order to avoid the vehicle 501 without displaying a travel path, the display control unit 14 displays an object indicating a travel path at a timing before electronic control is performed to change the autonomous steering wheel and accelerator, etc., by the control unit 13. Here, when the travel path is displayed on a head-up display, the display control unit 14 displays the travel path in a transparent reflective member, such as a windshield or a combiner, at a position overlapping the road ahead as viewed by the occupant of the vehicle 301. When the travel path is displayed on a center display, etc., the display control unit 14 superimposes the travel path on the road ahead of the vehicle 301, as in AR (Augmented Reality), on the image taken in front of the vehicle 301 by the camera mounted on the vehicle 301.

In the example of FIGS. 18A-18C, the display control unit 14 displays a travel path by an arrow-shaped graphical object 502A-object 502C extending gradually from the front of the present position of the vehicle 301 in the direction of movement of the vehicle 301. The display control unit 14 first displays the object 502A of FIG. 18A, which is relatively short, and then displays the object 502B of FIG. 18B and the object 502C of FIG. 18C in this order. In the example of FIGS. 18A-18C, the display control unit 14 displays the length of the object representing the travel path to appear to be extending, by gradually extending the object continuously.

The display control unit 14 also displays the change in acceleration of the vehicle 301 in the travel path, by the brightness and the color tone of the object indicating the travel path. In the example of FIGS. 18A-18C, the display control unit 14 indicates that the accelerator is electronically controlled by the control unit 13 so that when the brightness of the objects 502A to 502C is higher than a predetermined threshold value, as the brightness is higher, the acceleration in the traveling direction increases. Further, the display control unit 14 indicates that the electronic control of the brake is performed by the control unit 13 so that when the brightness of the objects 502A to 502C is lower than a predetermined threshold value, as the brightness is lower, the deceleration increases.

The display control unit 14 repeatedly extends and displays objects, such as arrows, from the front of the vehicle 301 to a predetermined distance in the moving direction of the vehicle 301, at each time point.

Next, another example of an object display screen illustrating an autonomous travel path of the vehicle 301 will be described with reference to FIGS. 19A-19C. FIGS. 19A through 19C are diagrams illustrating an example (part 2) of an object display screen indicating an autonomous travel path of the vehicle 301.

In the example of FIGS. 19A-19C, the display control unit 14 displays a travel path by a triangular, graphic object 601-object 607 extending gradually from the front of the vehicle 301 in the direction of movement of the vehicle 301. The display control unit 14 first displays the object 601 and the object 602 of FIG. 19A relatively close to the vehicle 301, and then displays the object 603 and the object 604 of FIG. 19B and the object 605 to the object 607 of FIG. 19C in in the stated order. The display control unit 14, in the example of FIGS. 19A-19C, displays the number of objects representing the travel path gradually and continuously increasing.

In addition, the display control unit 14 may move and display the objects in the direction of the autonomous movement of the vehicle 301 from the present position of the vehicle 301, instead of extending and displaying the objects indicating the travel path. In this case, the display control unit 14 may display objects 601 to 607, for example, in FIG. 19C, one by one.

Subsequently, in step S4, the control unit 13 detects that the predetermined change has been completed based on the information of the external environment of the vehicle 301 acquired from the sensor 200 by the acquiring unit 11. Here, the control unit 13 may determine that the predetermined change has been completed when, for example, the situation in which the direction or acceleration of the autonomous movement of the vehicle 301 should be changed by a predetermined threshold or more has been completed. In this case, the control unit 13 may determine that the predetermined change has been completed when, for example, the vehicle 301 is in a situation in which the vehicle 301 is to proceed substantially straight at a predetermined time or a predetermined distance or more at a substantially constant speed.

Subsequently, in step S5, the display control unit 14 erases the display of an object representing the autonomous travel path of the vehicle 301 and terminates the process. In the example of FIGS. 18A to 18C, the display control unit 14 repeatedly displays an object representing the travel path of the vehicle 301 at each time point when the control unit 13 determines that the temporary lane change, etc., to avoid the vehicle 501 has ended, until the electronic control for changing the control contents of the autonomous steering wheel, etc., is completed by the control unit 13, and then erases the display of the object. This makes it easier to monitor the driving situation of the vehicle 301, which is automatically driven by AI (Artificial Intelligence) or the like, because the occupant can view the travel path, etc., while the control content for the steering wheel, etc., is changed.

<Modification>

The display control unit 14 may also display an object indicating the travel path of the vehicle 301 at a period corresponding to the external environment of the vehicle 301 acquired from the sensor 200 by the acquiring unit 11. In this case, the display control unit 14 may, for example, display an object representing a travel path for a first time (e.g., 1 second) and erase the display of the object for a second time (e.g., 3 seconds). Accordingly, the traveling path can be visually recognized by the occupant at a period corresponding to the external environment even when, for example, no electronic control is performed which changes the control content of the autonomous steering wheel or the like by the control unit 13.

The display control unit 14 may determine the period, for example, based on the width, the number of lanes, and the type (either a highway or a public road) of the road on which the vehicle 301 is presently travelling. In this case, the display control unit 14 may, for example, determine a larger period as the width of the road on which the vehicle 301 is presently traveling increases and as the number of lanes increases. In addition, if the road on which the vehicle 301 is presently travelling is a highway, the period may be determined to a greater extent, than if the vehicle 301 is presently travelling on a general road. This allows the occupant to visually observe the travel path more frequently, on a road where the control content for the steering wheel, etc., is considered to be more frequently changed.

<Other>

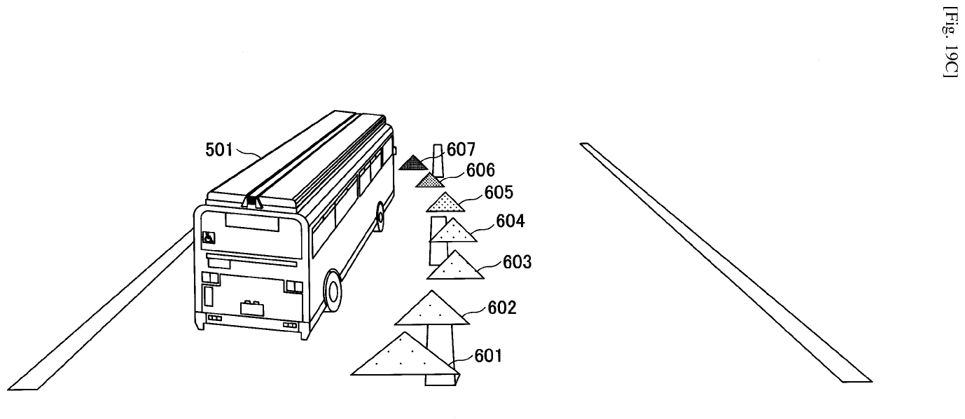

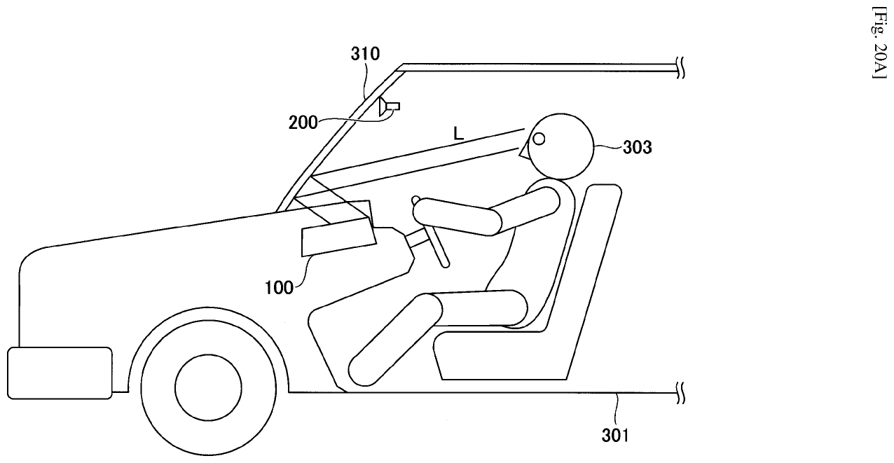

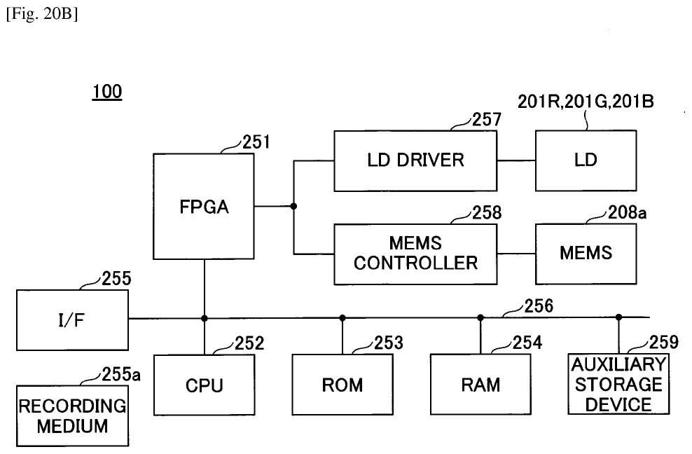

The information processing apparatus 100 may be configured as an integral device with a display device such as a HUD. In this case, the information processing apparatus 100 may also be referred to as a “display apparatus”. Hereinafter, an example where the information processing apparatus 100 and the HUD are configured as an integral device will be described. The system configuration in this case will be described with reference to FIG. 20A. FIG. 20A is a diagram illustrating an example of a system configuration of the autonomous driving system 1000 according to the embodiment. A display apparatus, including the information processing apparatus 100, is mounted, for example, in a dashboard of the vehicle 301. The projected light L, which is image light emitted from the display apparatus, is reflected by the windshield 310 as a light transmitting reflective member to an occupant 303 who is a viewer. Here, the transmissive reflective member is, for example, a member that transmits a portion of light and also reflects a portion of light. Thus, the image is projected onto the windshield 310 and the occupant 303 can overlay the object (content) such as a navigational geometry, character, icon, etc. onto the environment outside the vehicle 301. The inner wall surface of the windshield 310 or the like may be provided with a combiner as a transmissive reflective member to allow the driver to see the virtual image by the projected light L reflected by the combiner. FIG. 1B is a diagram illustrating an example of a range in which an image is projected by a display device including an information processing apparatus 100 according to an embodiment. The display projects an image, for example, to the projection area 311 in the windshield 310, as illustrated in FIG. 1B.

In this case, the display apparatus may be implemented with the hardware configuration illustrated in FIG. 20B. FIG. 20B is a diagram illustrating an example of a hardware configuration of a display device including an information processing apparatus 100 according to an embodiment. The display device includes an FPGA 251, a CPU (Central Processing Unit) 252, a ROM 253, a RAM 254, an interface (hereinafter referred to as an I/F) 255, a bus line 256, an LD driver 257, a MEMS controller 258, and an auxiliary storage device 259. The FPGA 251 operates and controls the laser light sources 201R, 201G, 201B of the light source unit 220 by the LD driver 257 and a MEMS 208a of the optical scanning device by the MEMS controller 258. The CPU 252 controls each function of the information processing apparatus 100. The ROM 253 stores various programs such as programs (image processing programs) that the CPU 252 executes to control the functions of the information processing apparatus 100.

The RAM 254 reads and stores the program from the ROM 253 or the auxiliary storage device 259 when the program startup instruction is received. The CPU 252 implements the functions pertaining to the information processing apparatus 100 according to a program stored in the RAM 254.

The I/F 255 is an interface for communicating with an external controller or the like, and is connected to an on-board ECU, various sensor devices, or the like, for example, via the CAN (Controller Area Network) of the vehicle 301.

The information processing apparatus 100 can read and write in a recording medium 255a through the I/F 255. An image processing program that achieves processing by the information processing apparatus 100 may be provided by the recording medium 255a. In this case, the image processing program is installed in the auxiliary storage device 259 through the I/F 255 from the recording medium 255a. However, the image processing program need not be installed from the recording medium 255a and may be downloaded from other computers via the network. The auxiliary storage device 259 stores the installed image processing program and stores the necessary files, data, and the like.

One example of the recording medium 255a is a portable recording medium such as a flexible disk, a CD-ROM, a DVD disk, an SD memory card, or a USB (Universal Serial Bus) memory. One example of the auxiliary storage device 259 is an HDD (hard disk drive) or flash memory. Both the recording medium 255a and the auxiliary storage device 259 correspond to a computer readable recording medium.

### Summary of Embodiment

According to the above-described embodiment, an object indicating the travel path is displayed at a timing corresponding to the environment outside the movable body, which autonomously moves in accordance with the travel path corresponding to the environment outside the movable body. This will improve visibility of the planned travel path.

<Other>

The functional units of the information processing apparatus 100 may be implemented by cloud computing, which is formed of one or more computers. In addition, at least one functional unit of the functional units of the information processing apparatus 100 may be configured as a separate device from an apparatus including the other functional units. In this case, for example, the calculating unit 12 and the control unit 13 may be configured with other ECUs, a server device on a cloud, or an on-board or portable display device. That is, the information processing apparatus 100 also includes a configuration including a plurality of devices. In addition, each functional unit of the information processing apparatus 100 may be implemented by hardware such as, for example, an ASIC (Application Specific Integrated Circuit).

### Third Embodiment

In the present embodiment, a display apparatus mounted on a movable body, such as a vehicle, displays a traveling image of a future movable body (own vehicle) in the future after the present time in a superimposed manner on a real environment, such as a road ahead of the present time.

FIG. 1A schematically illustrates the automobile 300 as an example of a movable body mounted with the display apparatus 1. In this example, the display apparatus 1 is an on-board head-up display (hereinafter referred to as “HUD”). The movable body in which the display apparatus 1 is mounted is not limited to the automobile 300, and the display apparatus 1 can be mounted on a movable body, such as a vehicle, a ship, an aircraft, an industrial robot, or the like. The automobile 300 has an adaptive cruise control (ACC: semi-automatic driving) function and is assumed to be capable of travelling by switching between semi-automatic driving and manual driving. However, the present invention is also applicable to vehicles that do not have an ACC function.

The display apparatus 1 is mounted, for example, on a dashboard or in a dashboard of the automobile 300, and projects a light image to a predetermined projection area 311 of windshield 310 in front of the passenger or driver (hereinafter referred to as “occupant P”).

The display apparatus 1 includes an optical apparatus 10 and a control apparatus 20. The control apparatus 20 primarily controls the generation and display of images projected onto the windshield 310. The optical apparatus 10 projects the generated image to the projection area 311 of the windshield 310. The configuration of the optical apparatus 10 is not illustrated in detail because it is not directly related to the present invention, but for example, laser light output from the laser light source is scanned two-dimensionally into a screen provided between the projection area 311 and the light source to form an intermediate image and project the intermediate image to the projection area 311, as will be described later. The screen may be formed of a microlens array, a micromirror array, or the like.

The projection area 311 of the windshield 310 is formed of a transparent reflective member that reflects a portion of the light and transmits another portion of the light. The intermediate image formed by the optical apparatus 10 is reflected in the projection area 311 and directed toward the occupant P. When the reflected light enters the pupils of the occupant P in the optical path indicated by the dashed lines, the occupant P visually recognizes the image projected to the projection area 311 of the windshield 310. At this time, the occupant P feels that the light image is entering his or her pupils through the light paths of the dotted lines from the virtual image position I. The displayed image is recognized as being present at the virtual image position I.

The virtual image at the virtual image position I is displayed superimposed on the real environment, e.g., on the road, in front of the automobile 300. In this sense, the image to be imaged at the virtual image position I may be referred to as an AR (Augmented Reality) image.

FIG. 21 illustrates the pitch angle, yaw angle, and roll angle of the automobile 300. As movements of an object with fixed anterior/posterior, left/right, and upper/lower positions, rolling is the rotation (or inclination) of the object relative to the anterior/posterior axis (Z axis in the figure), pitching is the rotation (or inclination) of the object relative to the left/right axis (X axis in the figure), and yawing is the rotation (or inclination) of the object relative to the upper/lower axis (Y axis in the figure). The rotation amounts or inclination amounts of the respective movements are referred to as the roll angle, the pitch angle, and the yaw angle.

FIG. 1B is a diagram illustrating an example of the projection area 311. The projection area 311 is a relatively small area disposed slightly below the front position of the windshield 310, for example, in view of the driver's seat. The line segment connecting the viewpoint of the occupant P with the virtual image position I is included within the range of the projection area 311, and the enlarged image is viewed at the virtual image position I.

The projection area 311 is not the same as the display area in which the images described below are displayed in a superimposed manner. The projection area 311 is a plane in which the light image formed by the laser light is projected, while the display area is outside the projection area 311 and is within the viewing field of the occupant P, and is a fixed area including the virtual image position I in which the light image displayed in a superimposed manner is formed. The display area is set to a position about several tens of meters ahead of the view of the occupant P, for example.

The automobile 300 may be equipped with the detecting device 5, such as a camera that acquires information about the surrounding environment of the automobile 300, LiDAR (Light Detection and Ranging: photodetection and ranging), etc. The detecting device 5 captures an image of an external environment such as, for example, the front, the side, or the like of the automobile 300. The detecting device 5 is an example of a sensor for acquiring external information and may use an ultrasonic radar, a laser radar, or the like, instead of or in combination with a camera.

FIG. 22 illustrates an example of a configuration of a display system in which the display apparatus 1 is mounted. A display system 150 includes the vehicle navigation device 400, a steering angle sensor 152, the display apparatus 1, and a vehicle speed sensor 154 interconnected via an in-vehicle network NW, such as a CAN (Controller Area Network) bus.

The vehicle navigation device 400 has a Global Navigation Satellite System (GNSS), such as GPS, which detects the present location of the vehicle and displays the location of the vehicle on an electronic map. The vehicle navigation device 400 also accepts input of the departure place and the destination, searches for the path from the departure place to the destination, displays the path on an electronic map, and guides the driver in the direction of travel by audio, text (displayed on the display), or animation, before changing the path. The vehicle navigation device 400 may communicate with a server via a mobile phone network or the like. In this case, it is possible for the server to transmit an electronic map to the automobile 300, perform a path search, or the like.

The steering angle sensor 152 is a sensor that detects the steering angle of the steering wheel by the driver. The steering angle sensor 152 mainly detects the direction of steering and the amount of steering. Any principle may be used for detection, for example, counting the ON/OFF of light passing through a rotating slit disc in conjunction with the steering wheel.

The vehicle speed sensor 154 detects, for example, the rotation of a wheel with a hole element and outputs a pulse wave corresponding to the rotation speed. The vehicle speed is detected from the revolution rate (number of pulses) of the unit time and the outside diameter of the tire.

The display apparatus 1 can acquire information from each sensor mounted on a vehicle. The display apparatus 1 may acquire information from an external network rather than from the in-vehicle network. For example, car navigation information, the steering angle of the steering wheel, or the vehicle speed can be acquired. For steering angles and vehicle speeds, in a case of applying automatic driving at a current or future time, it is considered possible to control the in-vehicle device by observing the position and speed of the vehicle using ITS (Intelligent Transport Systems).

FIG. 2 is an example of a hardware configuration of the display apparatus 1 of the embodiment. The optical apparatus 10 of the display apparatus 1 includes a laser diode (LD) 101 as a light source and a MEMS (Micro Electro Mechanical System) 102 as a light scanning device. The LD 101 includes, for example, laser elements that output red (R), green (G), and blue (B) light. The MEMS 102 scans the laser light output from the LD 101 two-dimensionally on a screen positioned between the LD 101 and the projection area 311 to render the light image. As a light scanning device, a polygon mirror, a galvano mirror, or the like may be used in addition to the MEMS.

The control apparatus 20 includes the FPGA (Field-Programmable Gate Array) 201, the CPU (Central Processing Unit) 202, the ROM (Read Only Memory) 203, the RAM (Random Access Memory) 204, the interface (hereinafter referred to as “I/F”) 205, the bus line 206, the LD driver 207, the MEMS controller 208, and the SSD (Solid State Drive) 209 as an auxiliary storage. The recording medium 211 may also be removably disposed.

The FPGA 201 controls the operation of the LD driver 207 and the MEMS controller 208. The LD driver 207 generates and outputs a drive signal that drives the LD 101 under the control of the FPGA 201. Drive signals control the emission timing of each laser element that emits light of R, G, and B. The MEMS controller 208 generates and outputs a MEMS control signal under the control of the FPGA 201 to control the scan angle and scan timing of the MEMS 102. Alternatively to FPGA 201, other logic devices such as PLG (Programmable Logic Device) may be used.

The CPU 202 controls the overall image data processing of the display apparatus 1. The ROM 203 stores a variety of programs including programs that the CPU 202 executes to control the functions of the display apparatus 1. The ROM 203 may store various image objects used for superimposed display of path images. The RAM 204 is used as the work area of the CPU 202.

The I/F 205 is an interface for communicating with an external controller or the like and is connected, for example, via the CAN bus of the automobile 300 to the detecting device 5, a vehicle navigation device, various sensor devices, and the like.

The display apparatus 1 can read from or write to the recording medium 211 through the I/F 205. An image processing program that implements processing by the display apparatus 1 may be provided by the recording medium 211. In this case, the image processing program is installed in the SSD 209 from the recording medium 211 through the I/F 205. Installation of the image processing program is not necessarily performed by the recording medium 211, but may be downloaded from another computer over the network. The SSD 209 stores the installed image processing program and stores the necessary files, data, etc.

One example of the recording medium 211 is a portable recording medium such as a flexible disk, a CD-ROM, a DVD disk, an SD memory card, and a USB (Universal Serial Bus) memory. As an auxiliary storage device, an HDD (hard disk drive), a flash memory, or the like may be used instead of the SSD 209. Both the auxiliary storage device, such as the SDD 209, and the recording medium 211 are computer-readable recording media.

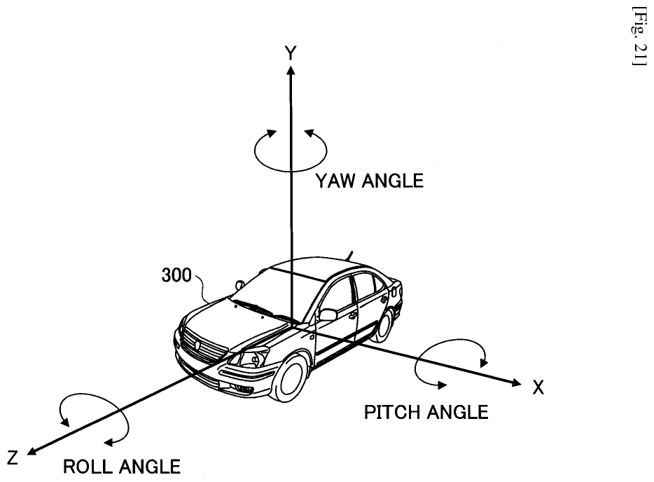

FIG. 23 is a schematic diagram illustrating the connection between the display apparatus 1 of the embodiment and other electronic devices mounted on the automobile 300. The display apparatus 1 includes an optical unit 230 and the image control unit 250. The optical unit 230 broadly corresponds to the optical apparatus 10, but the FPGA 201, the LD driver 207, and the MEMS controller 208 may be included in the optical unit 230. The image control unit 250 is implemented by at least a portion of the control apparatus 20.

The display apparatus 1 is connected to an electronic device such as the ECU 600, the vehicle navigation device 400, and the sensor group 500 via the I/F 205 and CAN. The sensor group 500 includes the steering angle sensor 152 and the vehicle speed sensor 154 of FIG. 22. If the detecting device 5 is installed in the automobile 300, the detecting device 5 may also be connected to the display apparatus 1 via I/F 205.

The display apparatus 1 acquires external information from the vehicle navigation device 400, the sensor group 500, the detecting device 5, and the like to detect the presence of intersections, curves, obstacles, and the like in front of the path in which the vehicle travels.

The sensor group 500 includes an acceleration sensor, a brake amount sensor, a steering wheel angle (steering angle) sensor, a tire angle sensor, an acceleration sensor, a gyro sensor (or yaw rate sensor), a vehicle speed sensor, a laser device, a brightness sensor, a rain drop sensor, and the like, and detects the behavior of the automobile 300, the surrounding environment, the distance between the vehicle and a vehicle traveling in front, and the like.

The vehicle navigation device 400 has navigation information including road maps, GPS information, traffic control information, construction information of each road, and the like.

The information acquired by the vehicle navigation device 400, the sensor group 500, and the detecting device 5 is supplied to the image control unit 250, and at least a portion of the acquired information is used to generate image data including the symbols of the future own vehicle.

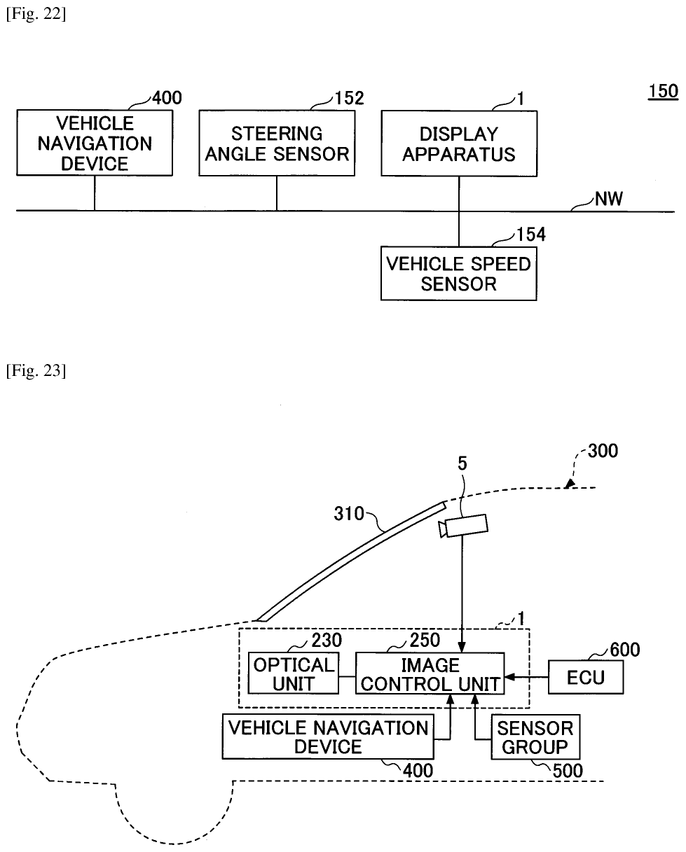

FIG. 24 is a functional block diagram of the image control unit 250. The image control unit 250 includes an information input unit 8800, an image analyzing unit 8810, a display timing acquiring unit 8820, an image data generating unit 8830, and an image rendering unit 8840.

The information input unit 8800 is implemented in the I/F 205, for example, and inputs information from the vehicle navigation device 400, the sensor group 500, the ECU 600, the detecting device 5, or the like. The information input unit 8800 includes an internal information input unit 88001 and an external information input unit 88002. Internal information is information representing the situation of the automobile 300 itself. The internal information input unit 88001 acquires the present position, speed, and angular speed information (yaw, roll, pitch) of the automobile 300 from the sensor group 500 and the ECU 600 through a CAN or the like. The yaw represents a left-to-right rotation of the vehicle and may be calculated from the angle of the steering or obtained from a 3-axis sensor. The roll represents the left and right slopes of the automobile 300, and the pitch represents the anterior/posterior slope of the automobile 300.

External information is information indicating the external conditions of the automobile 300 other than internal information. The external information input unit 88002 acquires navigation information, map information, and the like from the vehicle navigation device 400. Imaging information may also be acquired from the detecting device 5.

The image analyzing unit 8810 includes a road situation detecting unit 88110 and a vehicle change amount calculating unit 88120. The road situation detecting unit 88110 detects the road conditions, such as obstacles, intersections, and curves, based on the acquired external information. The vehicle change amount calculating unit 88120 calculates the change amount of the state such as the position of the vehicle based on the acquired internal information. The combination of the change amount of the road situation (or travelling situation) and the change amount of the vehicle situation may be referred to as “movement situation.” The image analyzing unit 8810 analyzes the movement situation of the own vehicle based on the external information and the internal information acquired by the information input unit 8800.

The display timing acquiring unit 8820 acquires timing information indicating the number of seconds or the number of meters ahead of the own vehicle's future image based on the internal and external information of the own vehicle acquired by the information input unit 8800 and the analysis information obtained by the image analyzing unit 8810. The timing calculation of how long the future image of the own vehicle is generated, may be performed by the display timing acquiring unit 8820 or may be performed by a computer external to the image control unit 250.

The image data generating unit 8830 generates image data including the symbol of the own vehicle at a certain point (or position) in the future based on the movement situation obtained by the image analyzing unit 8810. The “movement situation” is at least one of the situation of the road detected by the road situation detecting unit 88110 and the change amount in the state of the own vehicle obtained by the vehicle change amount calculating unit 88120. Road situations include the presence or absence of obstacles on the path to be driven, right and left turning paths, branches, intersections, etc. The change amount in the state of the vehicle includes the change amount in the position and attitude, and the change amount in the speed (acceleration/deceleration), etc.

The image data generating unit 8830 may read, as a symbol of a own vehicle, the object of the own vehicle stored, for example, in the ROM 203, and process the object by a three-dimensional computer graphics technology to generate the three-dimensional image data of the own vehicle at a certain time point in the future. In addition, the image data generating unit may use the previously stored image as a symbol of the vehicle. In this case, images of multiple angles corresponding to the symbol of the own vehicle may be stored and read out to be used. The symbol of the vehicle may be generated from an image obtained by capturing the actual vehicle or from a CAD image. In addition, the symbol of the own vehicle may be displayed as an image such as an icon.

The image rendering unit 8840 includes a control unit 88410 for controlling the projection operation of an image by the optical apparatus 10 based on the image data generated by the image data generating unit 8830. The image rendering unit 8840 may be implemented by the FPGA 201, the LD driver 207, and the MEMS controller 208. The image rendering unit 8840 renders a future light image of the own vehicle and the light image is projected to the projection area 311 of the windshield 310. As a result, a virtual image of a future own vehicle is displayed in a superimposed manner in the display area including the virtual image position I.

<Example of Superimposed Display of Future Own Vehicle>

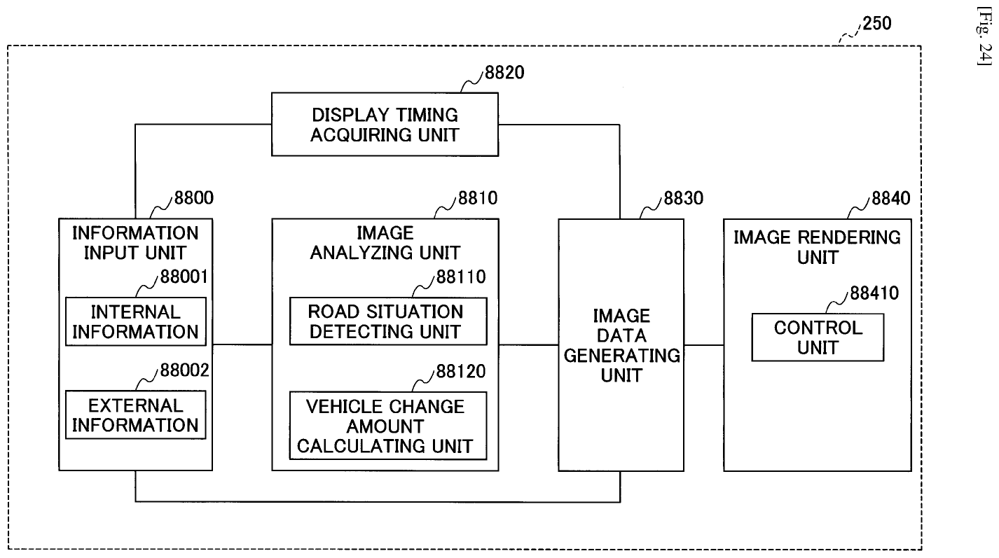

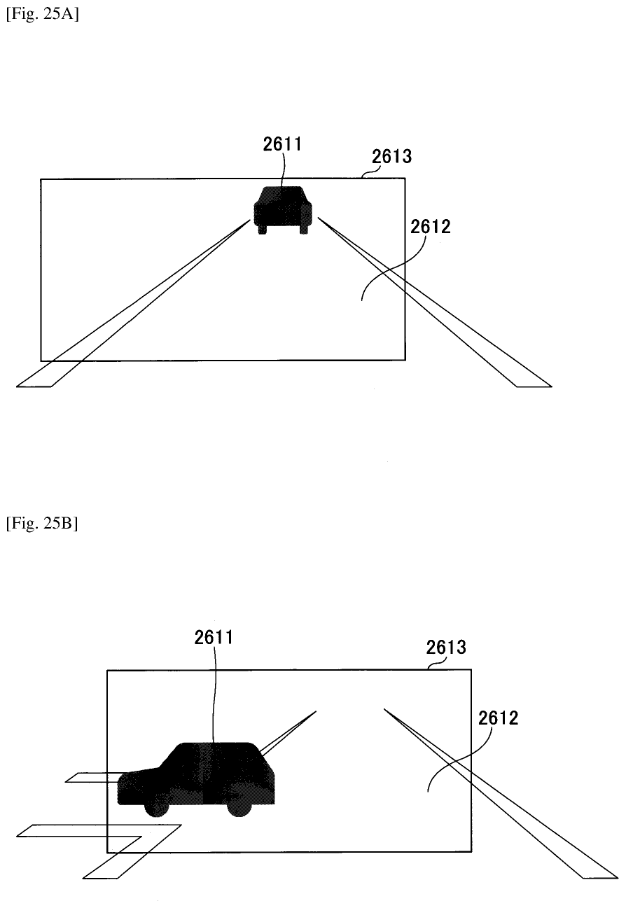

FIGS. 25A and 25B illustrate an example of a superimposed display of a symbol 2611 of a future own vehicle. The symbol 2611 of a future own vehicle is displayed as a virtual image, such that the symbol 2611 appears superimposed on a real environment within a predetermined display area 2613, e.g., on a road 2612 ahead to be driven. FIG. 25A is an image illustrating a future driving state of the own vehicle when the own vehicle is travelling stably. FIG. 25B is an image illustrating the driving state of the own vehicle at a future time when the driving mode of the own vehicle is significantly changed.

In FIG. 25A, when the change amount in the state of the own vehicle is small (such as less than a predetermined threshold value), or when no obstacle or right/left turning path is detected on the road 2612, the symbol 2611 of the future own vehicle traveling at a relatively distant time or position from the present point is displayed in the display area 2613 as, for example, a two-dimensional projection of a 3D image.

In FIG. 25B, when the change amount of the own vehicle's state is significantly large, or when an obstacle or a right/left turning path is detected on the road 2612, the symbol 2611 of a future own vehicle traveling in a more immediate future or a relatively near position is displayed in the display area 2613 as, for example, a two-dimensional projection of a 3D image.

A large change amount of the own vehicle means a large change in the vehicle speed (when the acceleration or deceleration rate is high) or a large change in the amount of yaw, pitch or roll. For example, the yaw rate and the rolling amount are greater when the vehicle is at a curve. The pitch increases when the vehicle is on a downhill or uphill path. When attempting to avoid an obstacle, the yaw rate increases but the speed decreases. When a lane is being changed, the yaw rate increases.

The image displayed in the display area 2613 is displayed in synchronization with the actual environment (in this example, the road 2612 ahead), the scale, and the sense of proximity, when viewed from the viewpoint of the occupant. The virtual image of the symbol 2611 of the relatively distant future own vehicle of in FIG. 25A appears to be small in the distance, and the virtual image of the symbol 2611 of the own vehicle in the relatively near future in FIG. 25A appears to be large in front.

This allows the occupant to intuitively recognize changes in driving situations and accurately recognize, for example, the timing of switching from a semi-automatic driving mode to a manual driving mode. Even in the case of the automobile 300 which does not have the ACC function, since the occupant is able to recognize the changes in the driving situation of the own vehicle in advance, it is possible to avoid delays in the operations of the steering wheel and the accelerator/brakes.

When the symbol 2611 of the own vehicle in a relatively near future occupies a large portion of the display area 2613, the transparency of the symbol 2611 of the future own vehicle may be changed so as not to interfere with the visibility of the occupant.

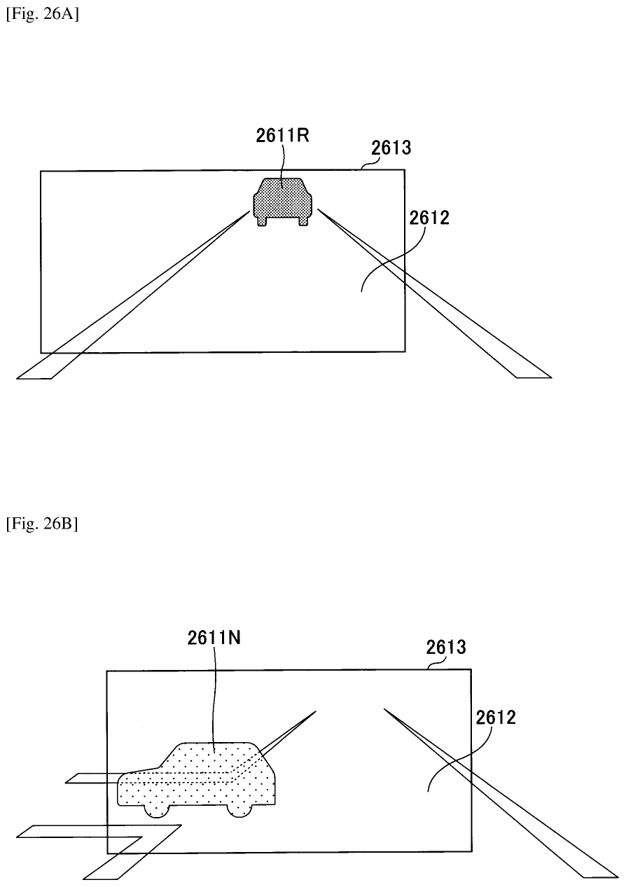

FIGS. 26A and 26B illustrate another example of a superimposed display of the symbol 2611 of a future own vehicle. A symbol 2611R of the relatively distant future own vehicle in FIG. 26A is displayed in dark color or low transparency because the symbol 2611R occupies a small proportion of the display area 2613. Since a symbol 2611N of the own vehicle in the relatively near future of FIG. 26B occupies a large proportion of the display area 2613, the symbol 2611N of the own vehicle in the future is displayed in a light color or with high transparency (in a semi-transparent state). By increasing the transparency of the traveling image of the symbol of the own vehicle in the near future, the occupant can see the actual background (road state).

The color of the symbol 2611 of the future own vehicle of FIGS. 26A and 26B may also be varied based on the difference between the present speed of the own vehicle and the speed of the own vehicle at a future time point. For example, in FIG. 26A, when the speed of the displayed future own vehicle is slower than the present speed of the own vehicle, the symbol 2611R of the future own vehicle is displayed in blue, and when the speed of the future own vehicle is faster than the present speed, the symbol 2611R of the future own vehicle is displayed in red. In this case, the occupant can intuitively recognize whether the brake operation will be performed or whether the accelerator operation will be performed in the own vehicle.

In addition, the symbol 2611R or the symbol 2611N of the own vehicle in the future displayed in the display area 2613, may be changed to a thin or small display at a predetermined time. For example, when other content (e.g., messages such as “Traffic congestion ahead, caution!”, and “Car in accident ahead!”) is displayed in the display area 2613 in an emergency, by changing the display the symbol 2611R or 2611N of the future own vehicle so that the symbol does not stand out, it is possible to alert the user to the emergency message.

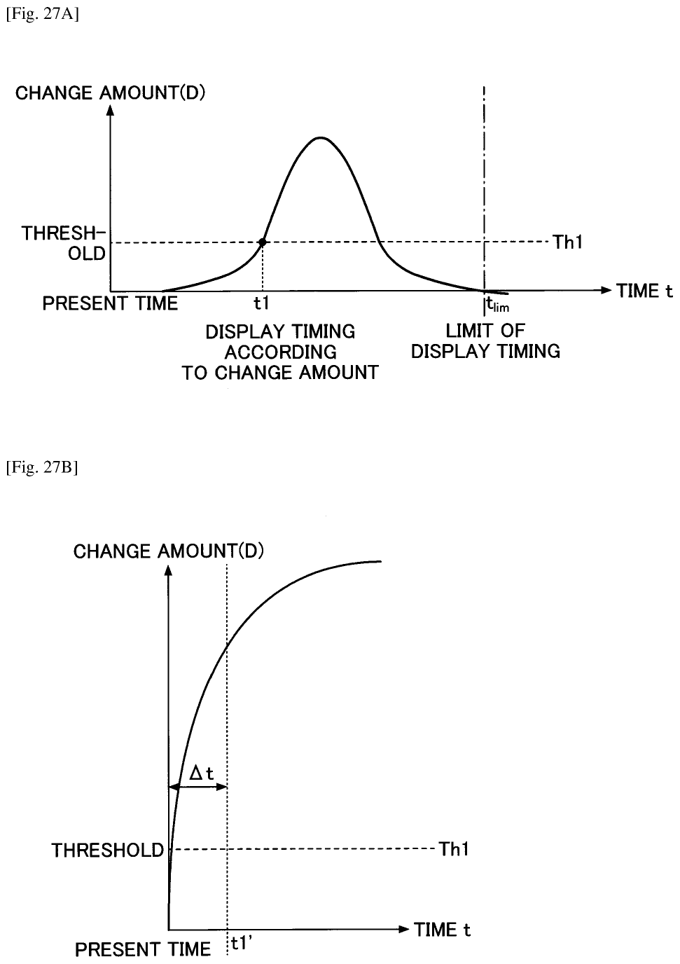

FIG. 27A is a diagram illustrating an example of calculating a display timing (how many seconds later the own vehicle is to be displayed) according to a change amount of the own vehicle. In FIG. 27A, the horizontal axis indicates the time and the vertical axis indicates a change amount D of the own vehicle. A time t=0 represents the present time, and a time t1 represents a future time point at which the change amount D exceeds a threshold value Th1.

For example, the change amount D is expressed by the following formula (1).

D=α×S(t)+β×V(t) (1)

Here, α and β are weighting coefficients (α+β=1), S is the change value based on steering angle of the steering wheel at a certain time point, and V is the change value based on the speed of the own vehicle at a certain time point. Both S and V are estimates at some time point. The estimated values are predicted based on the present values of steering angle of the steering wheel, the vehicle speed, and the history to date.

The change value for obtaining the change amount D is not limited to the steering angle of the steering wheel or the vehicle speed. Also, the change value is not limited to a function obtained by integrating the steering angle of the steering wheel and the vehicle speed. Multiple functions may be used by taking these parameters independently.

FIG. 27A is a graph plotting the change amount D calculated based on formula (1) at intervals of fixed time t after the present time. The predicted change amount D gradually increases from the present time, exceeds the threshold value Th1 at some point, then reaches a peak, and gradually decreases after the peak to less than the threshold Th. In this example, a symbol of the own vehicle is generated at a time t1 at which the predicted change amount D first exceeds the threshold value Th1.

FIG. 27B is a diagram illustrating a case where a timing exceeding a threshold value Th1 approaches a present time point. If the change amount has already significantly changed and the timing of exceeding the threshold substantially coincides with the present time, by generating and displaying the symbol of the own vehicle at time t1′ that is Δt after the present time, it is possible to alert the occupant.

On the other hand, if the threshold value Th1 is not exceeded at any time point on the time axis, the symbol 2611 of the future own vehicle may be displayed in the display area 2613 at a time tₗᵢₘ (see FIG. 27A) corresponding to the limit point of the predetermined display timing.

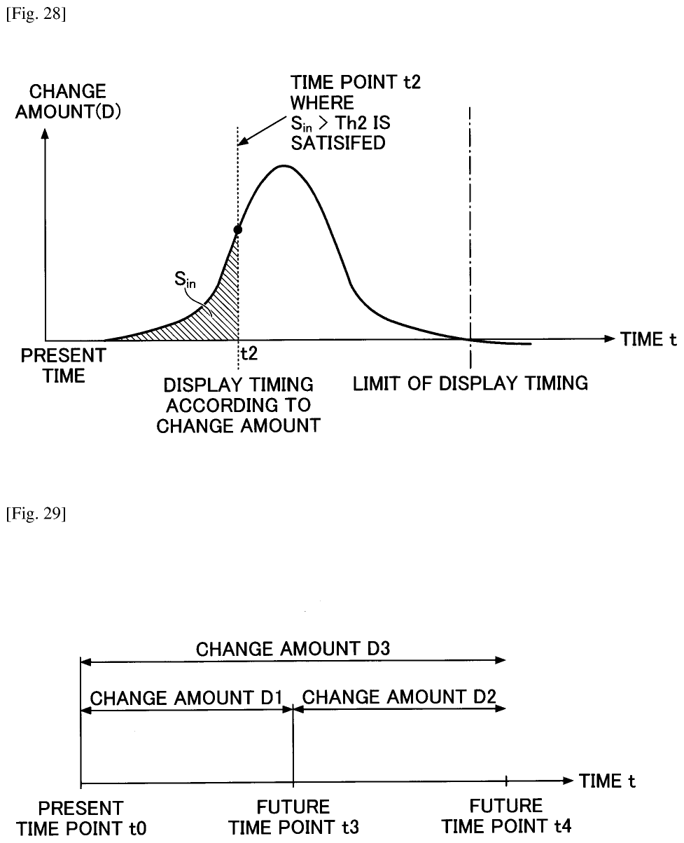

FIG. 28 is a diagram illustrating another example of the calculation of the display timing (the own vehicle of how many seconds later is to be displayed) according to the change amount of the own vehicle. FIG. 28 is a graph plotting the change amount D calculated based on formula (1) at intervals of time t after the present time. The predicted change amount gradually increases from the present time, reaches the peak at some point, and then gradually decreases after the peak.

The display timing is obtained by calculating the time t2 of when the area of the hatched area, calculated as the integral value Sᵢₙ of the change amount D from the present time to a certain time, exceeds a threshold value Th2 (Sᵢₙ>Th2). If the integral value Sᵢₙ does not exceed the threshold value Th2 at any time point on the time axis (i.e., if the change amount D is small), then the symbol 2611 of the future own vehicle at time tₗᵢₘ corresponding to the limit point of the predetermined display timing is displayed in the display area 2613.

In FIGS. 27A to 28, when an obstacle is detected, such as an a vehicle cutting in in the front or a pedestrian, etc., the change amount D as a function of time is recalculated in real time each time, so that the display of the symbol 2611 of the future own vehicle displayed in the display area 2613 also changes.

FIG. 29 is a diagram illustrating an example of acquiring a change amount of the state of an own vehicle. In FIGS. 27A to 28, the change amount D1 between the present time t0 and a future time t3 is obtained. However, as illustrated in FIG. 29, a change amount D2 between the different future time points t3 and t4 may be obtained. In addition, both the change amount D1 from the present time t0 to the first future time t3 and the change amount D3 from the present time t0 to the second future time t4 may be used. By considering multiple future timings, the estimation accuracy of the predicted driving state of the own vehicle is improved.

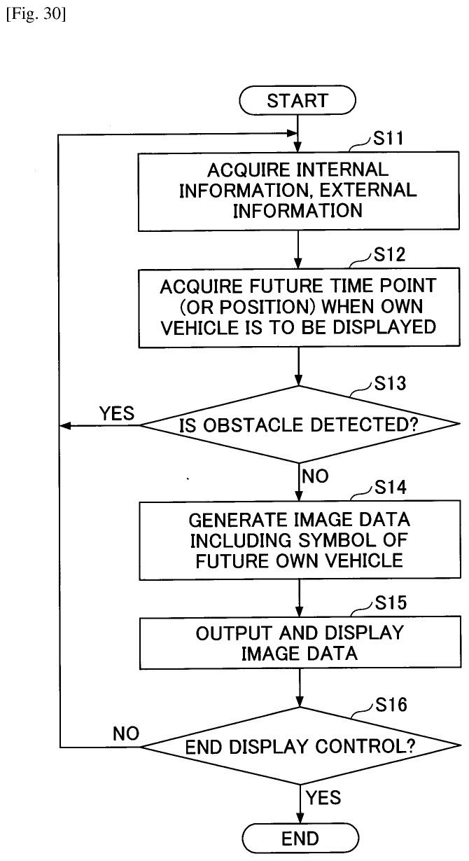

FIG. 30 is a flow chart of display control performed by the display apparatus 1. This control flow is performed by the image control unit 250 of the display apparatus 1.

The image control unit 250 acquires at least one of the internal information and the external information of the own vehicle (step S11). The internal information includes speed information, steering angle information (yaw, roll, pitch), tire angle information, and position information estimated by the own vehicle, obtained from the sensor group 500 and the ECU 600. The external information includes map information, imaging information, surrounding environment information, ranging information, etc., obtained from the vehicle navigation device 400, the detecting device 5, the sensor group 500 (laser radar, etc.), GPS, etc.

The image control unit 250 calculates the timing (or position) of the future own vehicle to be displayed in the present display area 2613 based on the acquired information (step S12). The calculation of the future timing (time point) is a time point that is a predetermined time Δt after the time point when the change amount of the state of the own vehicle exceeds a predetermined threshold value Th1, as illustrated in FIGS. 27A and 27B, or a time point when the integral value of the change amount exceeds a predetermined threshold value Th2, as illustrated in FIG. 28.

The display apparatus 1 also determines whether an obstacle has been detected in the path of the own vehicle to be driven from the acquired external information (step S13). When an obstacle such as a pedestrian, a vehicle cutting in, and a road construction, is detected (YES in step S13), the flow returns to step S11 to recalculate the timing or the position of the future own vehicle (step S12). When an obstacle is not detected in the path to be driven (NO in step S13), image data including the symbol of the future own vehicle is generated (step S14).

The generated image data is output, the laser light is scanned by the optical apparatus 10 to render a light image, and a virtual image of a future own vehicle is displayed in the display area (step S15). The rendering of the light image is not limited to the laser scanning method, and any projection means capable of forming the light image, such as a panel method, may be used as described below.

Steps S11 to S15 are repeated until the display control ends (NO in step S16). When the own vehicle finishes travelling (when the engine is turned off) or when an instruction of display control OFF is input, the display control is terminated (YES in step S16), and the process is terminated.

When this display control is executed by a program, the program for display control may be stored in the ROM 203 or the SSD 209, and the program may be read out and executed by the CPU 202. In this case, the CPU 202 executes at least the following procedure when generating image data of an image that appears to be superimposed on the surrounding environment from the viewpoint of the occupant of the movable body, (a) A procedure for generating image data comprising a symbol indicating the position of the movable body at a predetermined time in the future, based on at least one of the internal information and the external information of the automobile 300.

By using the above-described configuration and method, the occupant can intuitively recognize the motion of the own vehicle by displaying an image of the own vehicle in the future after the present time in a superimposed manner on the actual environment, and, therefore, even if the motion of the own vehicle changes significantly, the occupant can predict the operation of the own vehicle in advance.

The present invention is not limited to the embodiments described above. For example, instead of calculating the change amount of the own vehicle by a polynomial of the steering angle S of the steering wheel and the vehicle speed V, a polynomial of steering angle S of the steering wheel, the acceleration amount X, and the braking amount Y (S, X, Y) may be used to calculate the change amount of the own vehicle. In FIGS. 27A and 28, instead of calculating the change amount D as a function of time, the change amount D may be calculated as a function of the position of the future own vehicle to determine the position of the future own vehicle that is virtually displayed.

As the optical apparatus 10, a panel method may be adopted instead of a laser scanning method. Imaging devices such as a liquid crystal panel DMD (Digital Mirror Device) panel, and a dot fluorescent display tube (VFD: Vacuum Fluorescent Display) may be used as the panel method.

The projection area 311 of the windshield 310 may be provided with a combiner formed of a half-silvered mirror (half mirror, semitransparent mirror), hologram, or the like. A light transmission/reflection type reflection film may be vapor deposited between on the surface of or between the layers of the windshield 310.

At least a part of each function of the display apparatus 1 may be implemented by cloud computing configured of one or more computers.

The control apparatus, the display apparatus, the movable body, and the image display method are not limited to the specific embodiments described in the detailed description, and variations and modifications may be made without departing from the spirit and scope of the present invention.

The present application is based on and claims the benefit of priority of Japanese Priority Patent Application No. 2018-062548, filed on Mar. 28, 2018, Japanese Priority Patent Application No. 2018-063760, filed on Mar. 29, 2018, Japanese Priority Patent Application No. 2018-066207, filed on Mar. 29, 2018, Japanese Priority Patent Application No. 2019-050441, filed on Mar. 18, 2019, and Japanese Priority Patent Application No. 2019-050377, filed on Mar. 18, 2019, the entire contents of which are hereby incorporated herein by reference.

### REFERENCE SIGNS LIST

1 display apparatus
5 detecting device
10 optical apparatus
20 control apparatus
41, 41new guidance mark
42A-42C, 43A, 43B, 47 auxiliary image
250 image control unit
300 automobile (movable body)
310 windshield
311 projection area
400 vehicle navigation device
500 sensor group
600 ECU
800 information input unit
810 image analyzing unit
8110 obstacle detecting unit
820 image data generating unit
840 image rendering unit
8410 control unit

1. A control apparatus comprising:
an image data generator configured to generate image data of an image displayed so as to appear to be superimposed on a surrounding environment as viewed from an occupant of a movable body that autonomously travels based on a planned path that is defined in advance, wherein
a display mode of the image is changed based on information indicating a change in at least one of a travelling direction of the movable body and external information of the movable body.

2. The control apparatus according to claim 1, wherein the image data generator generates the image data including a first image indicating an object relating to the external information of the movable body concerning determination of the planned path of the movable body, based on a change in the external information of the movable body.

3. The control apparatus according to claim 2, wherein the image data generator generates the image data including the first image indicating the object concerning a change in the planned path, when changing the planned path of the movable body based on the object relating to the external information of the movable body.

4. The control apparatus according to claim 2, wherein the image data generator generates the image data including the first image indicating the object relating to the external information of the movable body, when the planned path of the movable body is not changed based on the object relating to the external information of the movable body.

5. The control apparatus according to claim 1, wherein the image data generator generates the image data including a second image indicating the planned path in which a change has been made, when changing the planned path of the movable body based on the change in the external information of the movable body.

6. The control apparatus according to claim 5, wherein the image data generator generates the image data including a third image indicating an operation of the movable body accompanying the change in the planned path, together with the planned path that has been changed.

7. The control apparatus according to claim 1, wherein the image data generator generates the image data including a third image indicating a position of the movable body at a predetermined future time point.

8. The control apparatus according to claim 7, wherein the image data generator determines the predetermined future time point based on a change amount of a state of the movable body.

9. The control apparatus according to claim 8, wherein the image data generator determines a time point at which the change amount exceeds a predetermined threshold, as the predetermined future time point.

10. The control apparatus according to claim 9, wherein the image data generator determines a predetermined time after a present time point as the predetermined future time point, when the time point at which the change amount exceeds the predetermined threshold is close to the present time point.

11. The control apparatus according to claim 8, wherein the image data generator determines a time point when a time integration value of the change amount exceeds a predetermined threshold, as the predetermined future time point.

12. A display apparatus comprising:
the control apparatus according to claim 1; and
an optical apparatus configured to project a light image based on the image data, onto a predetermined projection area of the movable body.

13. The movable body in which the display apparatus according to claim 12 is mounted.

14. An image display method comprising:
generating image data of an image displayed so as to appear to be superimposed on a surrounding environment as viewed from an occupant of a movable body that autonomously travels based on a planned path that is defined in advance; and
changing a display mode of the image based on information indicating a change in at least one of a travelling direction of the movable body and external information of the movable body.

15. A non-transitory computer-readable recording medium storing a program that causes a control apparatus installed in a movable body that autonomously travels based on a planned path that is defined in advance, to perform a method, comprising:
generating image data of an image displayed so as to appear to be superimposed on a surrounding environment as viewed from an occupant of the movable body; and
changing a display mode of the image based on information indicating a change in at least one of a travelling direction of the movable body and external information of the movable body.
